(19) United States
(12) Patent Application Publication
(10) Pub. No.: US 2025/0142526 A1
(43) Pub. Date: May 1, 2025

(54) METHOD AND APPARATUS FOR TRANSMITTING MEASUREMENT REPORT MESSAGE TO BS BY UE WHEN LEAVING CONDITION FOR EVENTAXHY IS SATISFIED IN NEXT-GENERATION MOBILE COMMUNICATION SYSTEM

(71) Applicant: Samsung Electronics Co., Ltd., Suwon-si (KR)

(72) Inventors: Sangyeob JUNG, Suwon-si (KR); Weiping SUN, Suwon-si (KR)

(21) Appl. No.: 18/925,782

(22) Filed: Oct. 24, 2024

(30) Foreign Application Priority Data
Oct. 27, 2023 (KR) 10-2023-0145824

(51) Int. Cl. H04W 64/00

(52) U.S. Cl. CPC H04W 64/006

(57) ABSTRACT

The disclosure relates to a 5G or a 6G communication system for supporting a higher data transmission rate. The disclosure proposes a method and an apparatus for transmitting a measurement report message to a BS when a UE satisfies a predetermined condition in a mobile communication system.

### CROSS-REFERENCE TO RELATED APPLICATION(S)

This application is based on and claims priority under 35 U.S.C. § 119 (a) of a Korean patent application number 10-2023-0145824, filed on Oct. 27, 2023, in the Korean Intellectual Property Office, the disclosure of which is incorporated by reference herein in its entirety.

### BACKGROUND

### 1. Field

The disclosure relates to user equipment (UE) and base station (BS) operations in a mobile communication system.

### 2. Description of Related Art

Fifth generation (5G) mobile communication technologies define broad frequency bands to enable high transmission rates and new services, and can be implemented not only in “Sub 6 GHz” bands such as 3.5 GHZ, but also in “Above 6 GHz” bands referred to as millimeter-wave (mmWave) including 28 GHz and 39 GHz. In addition, it has been considered to implement sixth generation (6G) mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive multiple-input multiple-output (MIMO) for alleviating radio-wave path loss and increasing radio-wave transmission distances in mm Wave, numerology (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large-capacity data transmission and a polar code for highly reliable transmission of control information, Layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step Random Access Channel (RACH) for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus in which an uncrewed aerial vehicle (UAV) UE transmits an event-based measurement result message to a BS by applying altitude-based synchronization signal block (SSB) measurement configuration information.

Another aspect of the disclosure is to provide a method and an apparatus in which the UAV UE transmits an event AxHy-based measurement result message to the BS.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes transmitting, to a base station, a first message comprising information indicating that the terminal supports configuration information on an altitude based measurement, receiving, from the base station, a second message comprising the configuration information on the altitude based measurement, the configuration information on the altitude based measurement comprising information on an altitude range, identifying whether the terminal is within the altitude range indicated by the information on the altitude range, in case that the terminal is within the altitude range, performing a measurement based on the configuration information on the altitude based measurement, and transmitting, to the base station, a third message comprising a result on the measurement, wherein, after entering the altitude range, the terminal considers the terminal to be in the altitude range while an altitude of the terminal is larger than or equal to a minimum altitude minus a hysteresis value and the altitude of the terminal is smaller than or equal to a maximum altitude plus the hysteresis value.

In an embodiment, after entering the altitude range, the terminal considers the terminal to be in the altitude range while an altitude of the terminal is larger than or equal to a minimum altitude minus a hysteresis value and the altitude of the terminal is smaller than or equal to a maximum altitude plus the hysteresis value.

In an embodiment, in case that information on the minimum altitude is absent in the information on the altitude range, the minimum altitude is −420 m.

In an embodiment, in case that information on the maximum altitude is absent in the information on the altitude range, the maximum altitude is 10000m in case that information on the maximum altitude is absent in the information on the altitude range, the maximum altitude is 10000m.

In an embodiment, in case that the altitude of the terminal is larger than or equal to the minimum altitude and the altitude of the terminal is smaller than or equal to the maximum altitude, the terminal considers to have entered the altitude range.

In an embodiment, the performing comprises in case that configuration information on at least one synchronization signal block (SSB) to be measured for the altitude range is absent in the configuration information on the altitude based measurement, performing the measurement on all SS blocks.

In an embodiment, the method further comprises in case that the terminal is outside altitude ranges indicated by the information on the altitude range, performing a measurement based on information on at least one synchronization signal block (SSB) to be measured not for the altitude range.

In accordance with another aspect of the disclosure, a method performed by a base station in a wireless communication system is provided. The method includes receiving, from a terminal, a first message comprising information indicating that the terminal supports configuration information on an altitude based measurement, transmitting, to the terminal, a second message comprising the configuration information on the altitude based measurement, the configuration information on the altitude based measurement comprising information on an altitude range, and receiving, from the terminal, a third message comprising a result on a measurement, wherein, in case that the terminal is within the altitude range, the result on the measurement comprises a result on a measurement based on the configuration information on the altitude based measurement, and wherein, after entering the altitude range, the terminal is considered to be in the altitude range while an altitude of the terminal is larger than or equal to a minimum altitude minus a hysteresis value and the altitude of the terminal is smaller than or equal to a maximum altitude plus the hysteresis value.

In an embodiment, in case that the terminal is within the altitude range, the result on the measurement comprises a result on a measurement based on the configuration information on the altitude based measurement.

In an embodiment, after entering the altitude range, the terminal is considered to be in the altitude range while an altitude of the terminal is larger than or equal to a minimum altitude minus a hysteresis value and the altitude of the terminal is smaller than or equal to a maximum altitude plus the hysteresis value.

In an embodiment, in case that the altitude of the terminal is larger than or equal to the minimum altitude and the altitude of the terminal is smaller than or equal to the maximum altitude, the terminal is considered to have entered the altitude range.

In an embodiment, in case that configuration information on at least one synchronization signal block (SSB) to be measured for the altitude range is absent in the configuration information on the altitude based measurement, the result on the measurement comprises a result on a measurement on all SS blocks.

In an embodiment, in case that the terminal is outside altitude ranges indicated by the information on the altitude range, the result on the measurement comprises a result on a measurement based on information on at least one synchronization signal block (SSB) to be measured not for the altitude range.

In accordance with another aspect of the disclosure, a terminal in a wireless communication system is provided. The terminal includes a transceiver and a controller configured to transmit, to a base station via the transceiver, a first message comprising information indicating that the terminal supports configuration information on an altitude based measurement, receive, from the base station via the transceiver, a second message comprising the configuration information on the altitude based measurement, the configuration information on the altitude based measurement comprising information on an altitude range, identify whether the terminal is within the altitude range indicated by the information on the altitude range, in case that the terminal is within the altitude range, perform a measurement based on the configuration information on the altitude based measurement, and transmit, to the base station via the transceiver, a third message comprising a result on the measurement, wherein, after entering the altitude range, the terminal considers the terminal to be in the altitude range while an altitude of the terminal is larger than or equal to a minimum altitude minus a hysteresis value and the altitude of the terminal is smaller than or equal to a maximum altitude plus the hysteresis value.

In accordance with another aspect of the disclosure, a base station in a wireless communication system is provided. The base station includes a transceiver and a controller configured to receive, from a terminal via the transceiver, a first message comprising information indicating that the terminal supports configuration information on an altitude based measurement, transmit, to the terminal via the transceiver, a second message comprising the configuration information on the altitude based measurement, the configuration information on the altitude based measurement comprising information on an altitude range and receive, from the terminal via the transceiver, a third message comprising a result on a measurement, wherein, in case that the terminal is within the altitude range, the result on the measurement comprises a result on a measurement based on the configuration information on the altitude based measurement, and wherein, after entering the altitude range, the terminal is considered to be in the altitude range while an altitude of the terminal is larger than or equal to a minimum altitude minus a hysteresis value and the altitude of the terminal is smaller than or equal to a maximum altitude plus the hysteresis value.

According to an embodiment of the disclosure, a method and an apparatus in which an uncrewed aerial vehicle (UAV) UE transmits an event-based measurement result message to a BS by applying altitude-based synchronization signal block (SSB) measurement configuration information are provided.

Further, according to an embodiment of the disclosure, a method and an apparatus in which the UAV UE transmits an event AxHy-based measurement result message to the BS are provided.

Other aspects, advantages, and salient features of the disclosure will become apparent to those skilled in the art from the following detailed description, which, taken in conjunction with the annexed drawings, discloses various embodiments of disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of a long term evolution (LTE) system according to an embodiment of the disclosure;

FIG. 1B illustrates a radio protocol structure of an LTE system according to an embodiment of the disclosure;

FIG. 1C illustrates a structure of a next-generation mobile communication system according to an embodiment of the disclosure;

FIG. 1D illustrates a radio protocol structure of a next-generation mobile communication system according to an embodiment of the disclosure;

FIG. 1E is a flowchart illustrating a process in which an uncrewed aerial vehicle (UAV) UE transmits an event-based measurement result message to a gNB by applying altitude-based SSB measurement configuration information in a next-generation mobile communication system according to an embodiment of the disclosure;

FIG. 1F is a flowchart illustrating a process in which an uncrewed aerial vehicle (UAV) UE transmits an event AxHy-based measurement result message to a gNB in a next-generation mobile communication system according to an embodiment of the disclosure;

FIG. 1G is a flowchart illustrating a process in which an uncrewed aerial vehicle (UAV) UE transmits an event AxHy-based measurement result message to a gNB in a next-generation mobile communication system according to an embodiment of the disclosure;

FIG. 1H is a flowchart illustrating a process in which an uncrewed aerial vehicle (UAV) UE transmits an event AxHy-based measurement result message to a gNB in a next-generation mobile communication system according to an embodiment of the disclosure;

FIG. 1I is a block diagram illustrating an internal structure of a UE according to an embodiment of the disclosure; and

FIG. 1J is a block diagram illustrating a configuration of a base station (BS) according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the accompanying drawings, some elements may be exaggerated, omitted, or schematically illustrated. Furthermore, the size of each element does not completely reflect the actual size.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational to be performed on the computer or other programmable data processing apparatus to produce a computer implemented process may provide operations for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

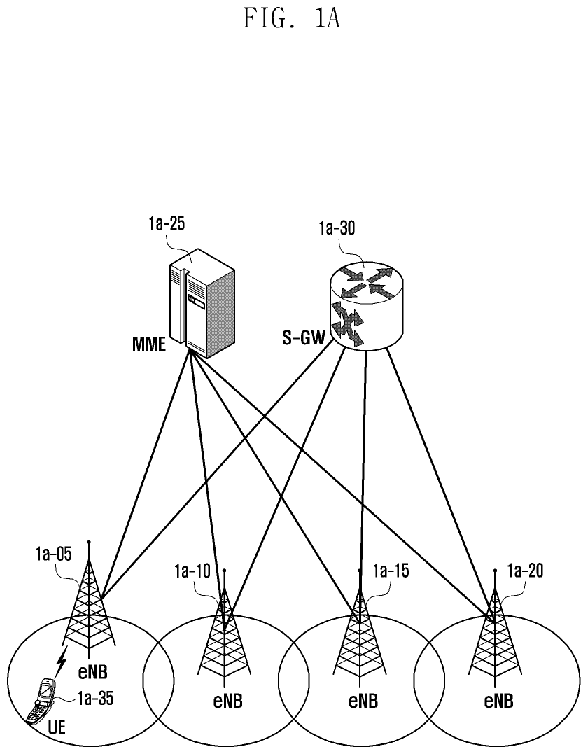

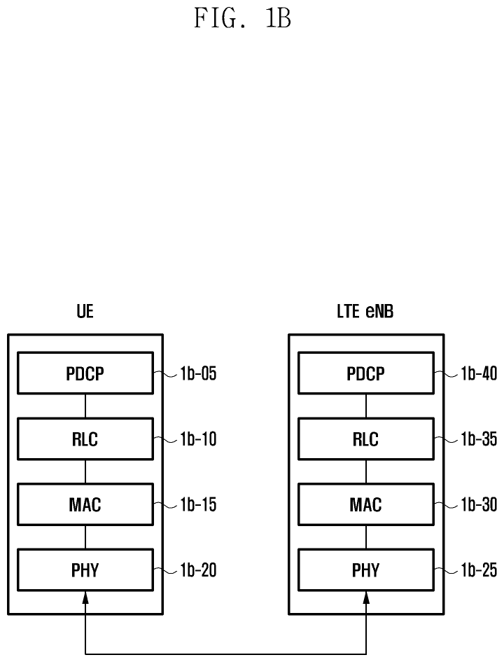

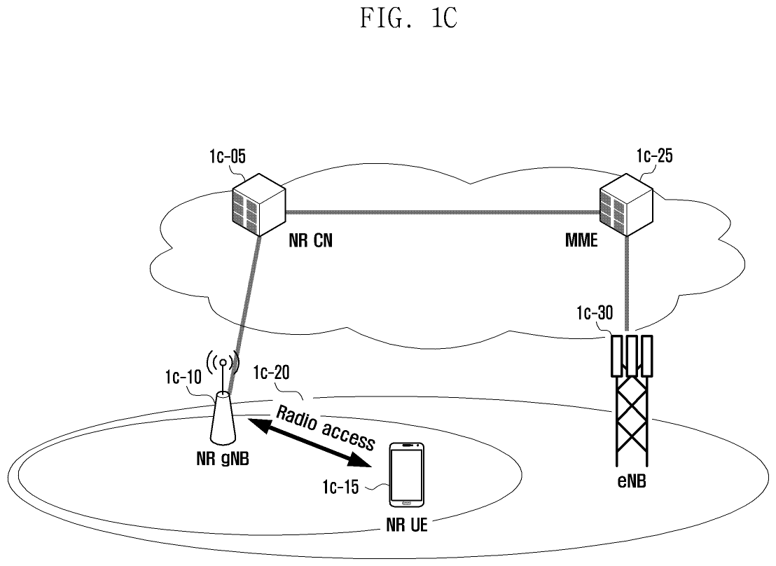

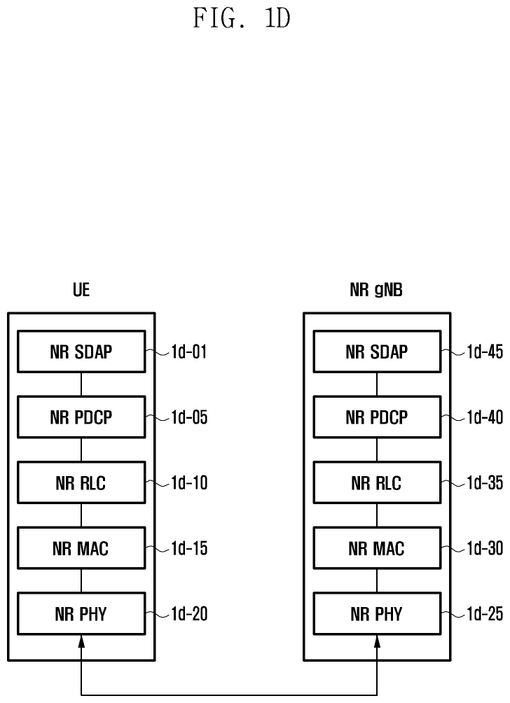

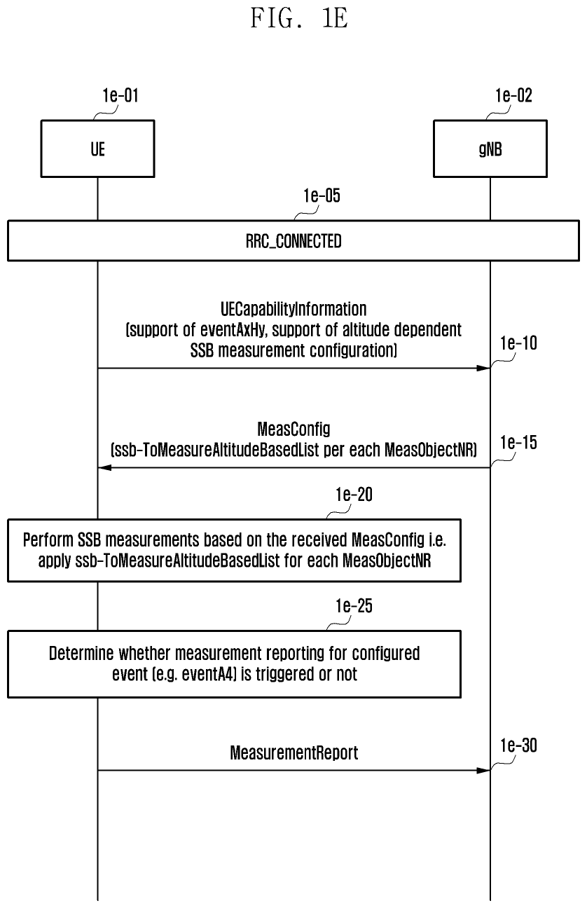

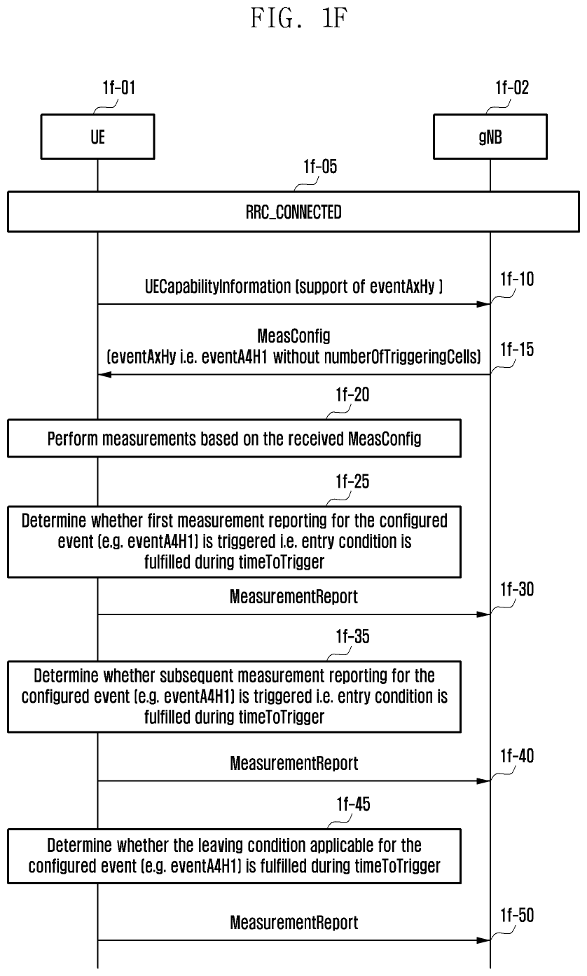

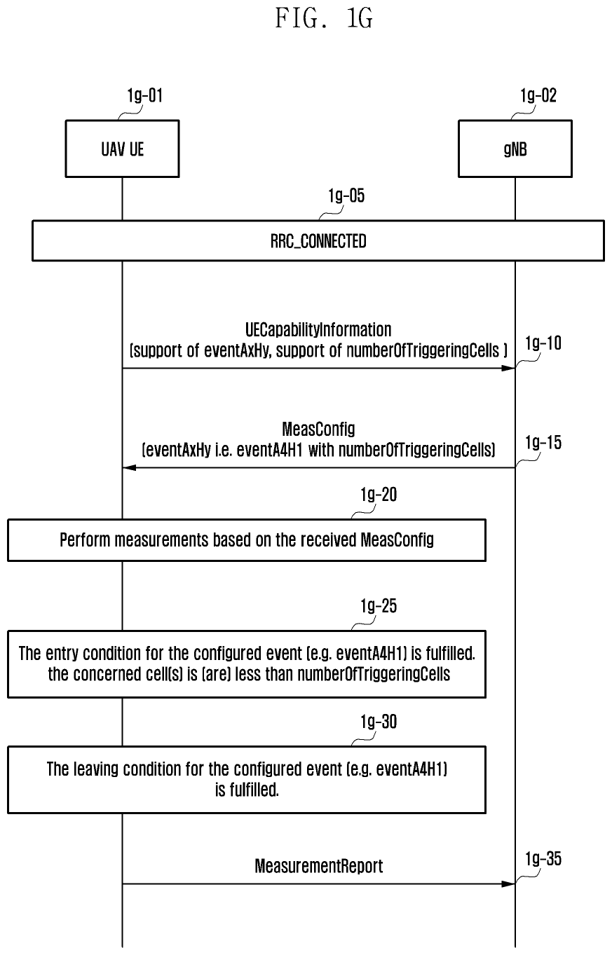

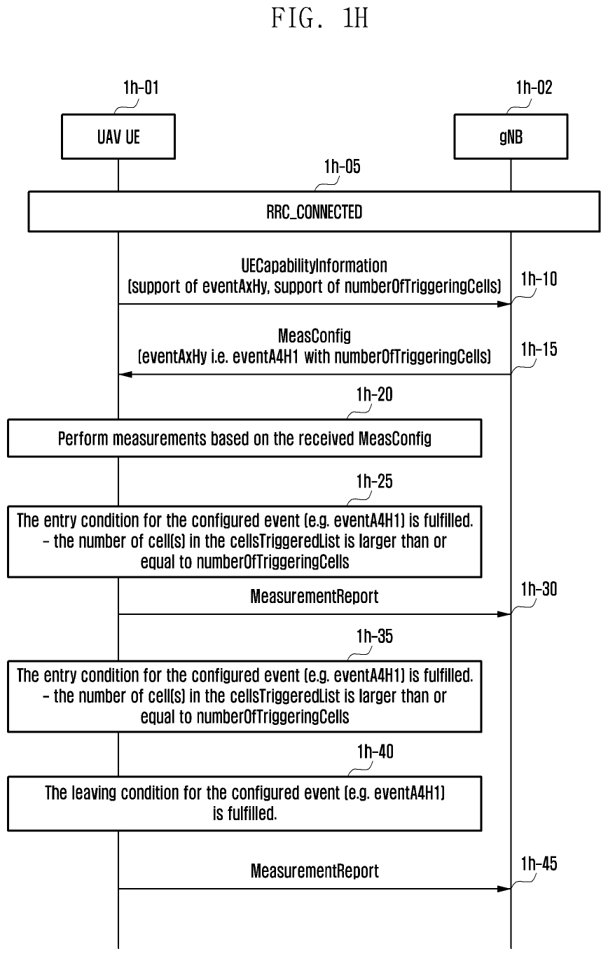

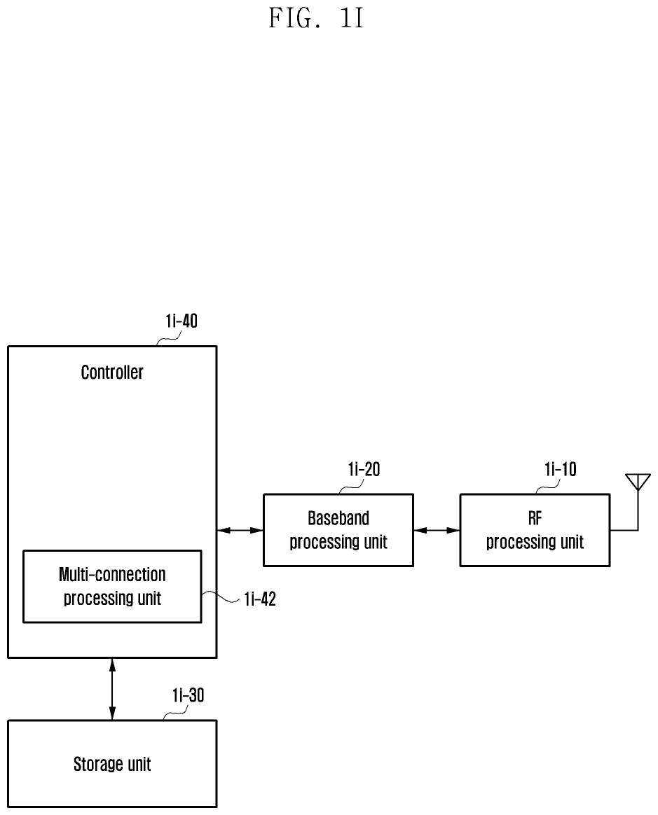

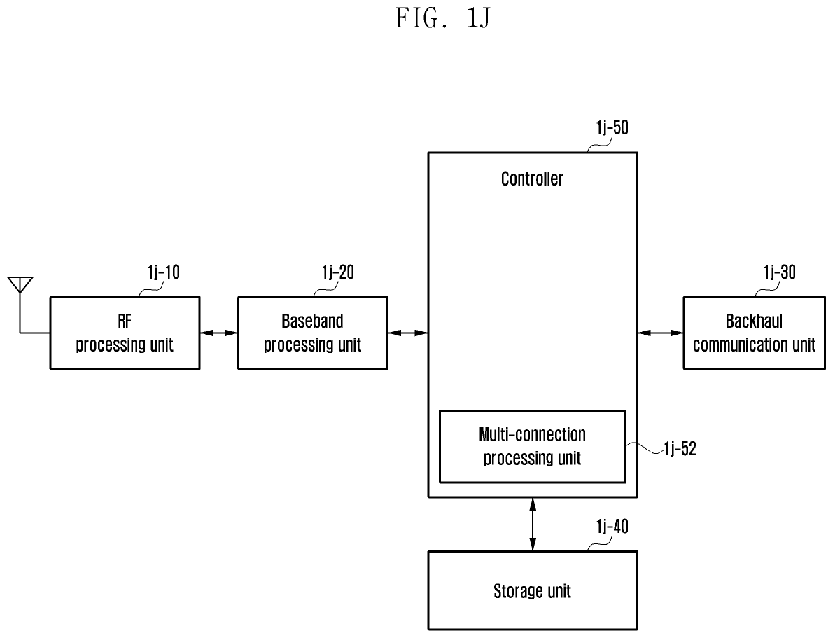

FIG. 1A illustrates a structure of an LTE system according to an embodiment of the disclosure.

Referring to FIG. 1A, as illustrated therein, a radio access network of an LTE system may include next-generation base stations (evolved node Bs, hereinafter ENBs, eNBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 may access an external network through the ENBs 1a-05 to 1a-20 and the S-GW 1a-30.

In FIG. 1A, the ENBs 1a-05 to 1a-20 may correspond to conventional node Bs of a universal mobile telecommunication system (UMTS). The ENBs 1a-05 to 1a-20 are connected to the UE 1a-35 through a radio channel, and perform more complicated roles than the conventional node Bs. In the LTE system, since all user traffic including real-time services, such as voice over Internet protocol (VOIP) via the Internet protocol, is serviced through a shared channel, a device that collects state information, such as buffer states, available transmit power states, and channel states of UEs, and performs scheduling accordingly is required, and the ENBs 1a-05 to 1a-20 serve as the device. In general, one ENB 1a-05 to 1a-20 controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHZ. Furthermore, the LTE system employs an adaptive modulation & coding (hereinafter referred to as AMC) scheme for determining a modulation scheme and a channel coding rate according to a channel state of a UE 1a-35. The S-GW 1a-30 is a device that provides a data bearer, and may generate or remove a data bearer under the control of the MME 1a-25. The MME 1a-25 is a device responsible for various control functions as well as a mobility management function for a UE 1a-35, and is connected to multiple base stations 1a-05 to 1a-20.

FIG. 1B illustrates a radio protocol structure of an LTE system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, a medium access control (MAC) 1b-15 or 1b-30, and a physical layer (PHY) 1b-20 or 1b-25 on each of UE and ENB sides.

The packet data convergence protocol (PDCP) 1b-05 or 1b-40 is responsible for operations such as IP header compression/reconstruction. The main functions of the PDCP 1b-05 or 1b-40 may be summarized as follows.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 1b-10 or 1b-35 may reconfigure a PDCP protocol data unit (PDU) into an appropriate size to perform an automatic repeat request (ARQ) operation. The main functions of the RLC 1b-10 or 1b-35 may be summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for unacknowledged mode (UM) and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 may be connected to several RLC layer devices configured in a single terminal, and multiplex RLC PDUs into a MAC PDU and demultiplex a MAC PDU into RLC PDUs. The main functions of the MAC 1b-15 or 1b-30 are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

The physical layer (PHY) 1b-20 or 1b-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1C illustrates a structure of a next-generation mobile communication system according to an embodiment of the disclosure.

Referring to FIG. 1C, as illustrated therein, a radio access network of a next-generation mobile communication system (hereinafter NR or 5G) may include a next-generation base station (new radio node B, hereinafter NR gNB, gNB, NR base station, or base station) 1c-10, and a new radio core network (NR CN) 1c-05. A user terminal (new radio user equipment, hereinafter NR UE or NR terminal) 1c-15 may access an external network via the NR gNB 1c-10 and the NR CN 1c-05.

In FIG. 1C, the NR gNB 1c-10 corresponds to an evolved node B (eNB) 1c-30 of a conventional LTE system. The NR gNB 1c-10 may be connected to the NR UE 1c-15 through a radio channel via radio access 1c-20 and may provide outstanding services as compared to a conventional node B. In the next-generation mobile communication system, since all user traffic is serviced through a shared channel, a device that collects state information, such as buffer statuses, available transmit power states, and channel states of UEs 1c-15, and performs scheduling accordingly is required, and the NR gNB 1c-10 serves as the device. In general, one NR gNB 1c-10 controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE 1c-15. The NR CN 1c-05 may perform functions such as mobility support, bearer configuration, and quality of service (QOS) configuration. The NR CN 1c-05 is a device responsible for various control functions as well as a mobility management function for a UE 1c-15, and may be connected to multiple base stations 1c-10. In addition, the next-generation mobile communication system may interwork with the existing LTE system, and the NR CN 1c-05 may be connected to an MME 1c-25 via a network interface. The MME 1c-25 may be connected to an eNB 1c-30 that is an existing base station.

FIG. 1D illustrates a radio protocol structure of a next-generation mobile communication system according to an embodiment of the disclosure.

Referring to FIG. 1D, a radio protocol of a next-generation mobile communication system may include an NR service data adaptation protocol (SDAP) 1d-01 or 1d-45, an NR PDCP 1d-05 or 1d-40, an NR RLC 1d-10 or 1d-35, an NR MAC 1d-15 or 1d-30, and NR PHY 1d-20 or 1d-25 on each of UE and NR base station (NR gNB) sides.

The main functions of the NR SDAP 1d-01 or 1d-45 may include some of functions below.
Transfer of user plane data
Mapping between a QoS flow and a data radio bearer (DRB) for both downlink (DL) and uplink (UL)
Marking QoS flow ID in both DL and UL packets
Reflective QoS flow to DRB mapping for UL SDAP PDUs

With regard to the SDAP layer device, the UE may be configured, through a radio resource control (RRC) message, whether to use the header of the SDAP layer device or whether to use functions of the SDAP layer device for each PDCP layer device or each bearer or each logical channel, and if an SDAP header is configured, the non-access stratum (NAS) QOS reflection configuration 1-bit indicator (NAS reflective QoS) and the access stratum (AS) QOS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1d-05 or 1d-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 1d-10 or 1d-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to an upper layer, may include a function of, although there is a lost RLC SDU, if a predetermined timer has expired, sequentially transferring, to an upper layer, all the RLC SDUs received before the timer is started, or may include a function of, although there is a lost RLC SDU, if a predetermined timer has expired, sequentially transferring all the RLC SDUs received up to the current, to an upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1d-15 or 1d-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR physical layer (PHY) 1d-20 or 1d-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1E is a flowchart illustrating a process in which an uncrewed aerial vehicle (UAV) UE transmits an event-based measurement result message to a gNB by applying altitude-based SSB measurement configuration information in a next-generation mobile communication system according to an embodiment of the disclosure.

The UAV UE may be a UE that is able to fly. Accordingly, the UAV UE has a characteristic of having a higher probability of line of sight than a terrestrial UE. Therefore, the UAV UE may have a disadvantage of receiving downlink (hereinafter, referred to as DL) interference from more cells compared to the terrestrial UE. That is, the UAV UE has a characteristic of receiving DL interference at a high level from more neighboring cells compared to the terrestrial UE. Similarly, the UAV UE has a characteristic of giving uplink (hereinafter, referred to as UL) to more cells compared to the terrestrial UE. Accordingly, the gNB may support the UAV UE by adjusting predetermined beams in a direction of the sky (beam uptilting). This is for the BS to optimally operate a predetermined frequency by differently putting configuration information of beams which should be measured according to an altitude of the UAV UE. For example, when the UAV UE measures a predetermined frequency, the BS may configure only predetermined beams for each specific altitude range to be measured, and such configuration information may be singular or plural.

Referring to FIG. 1E, in operation 1e-05, the UAV UE 1e-01 may establish an RRC connection with the NR gNB 1e-02 to be in an RRC-connected mode (RRC_CONNECTED).

In operation 1e-10, the UAV UE 1e-01 may transmit a UE capability information message (UECapabilityInformation) to the gNB 1e-02. The message may include at least the following capability information.
Capability information indicating whether altitude or height-based synchronization signal block (SSB) measurement configuration information (SSB-ToMeasureAltitudeBasedList) is supported.

In operation 1e-15, the gNB 1e-02 may transmit a predetermined RRC message (for example, RRCReconfiguration) containing measurement configuration information (MeasConfig) to the UE 1e-01. For example, MeasConfig may include measurement target configuration information (MeasObjectToAddModList) on targets which the UE 1e-01 measures, report configuration information (ReportConfigToAddModList), measurement identifier configuration information (MeasIdToAddModList) for identifying a measurement configuration through a connection between one report configuration and one measurement target configuration information, measurement quantity configuration information (QuantityConfig) containing measurement quantities and layer 3 filtering coefficients for measurement, and the like. MeasConfig may have a format of abstract syntax notation number one (ASN.1) as shown in Table 1 below.

TABLE 1

| MeasConfig ::= | SEQUENCE { | |
|---|---|---|
| measObjectToRemoveList | MeasObjectToRemoveList | OPTIONAL, -- Need N |
| measObjectToAddModList | MeasObjectToAddModList | OPTIONAL, -- Need N |
| reportConfigToRemoveList | ReportConfigToRemoveList | OPTIONAL, -- Need N |
| reportConfigToAddModList | ReportConfigToAddModList | OPTIONAL, -- Need N |
| measIdToRemoveList | MeasIdToRemoveList | OPTIONAL, -- Need N |
| measIdToAddModList | MeasIdToAddModList | OPTIONAL, -- Need N |
| s-MeasureConfig | CHOICE { | |
| ssb-RSRP | RSRP-Range, | |
| csi-RSRP | RSRP-Range | |
| } | | OPTIONAL, -- Need M |
| quantityConfig | QuantityConfig | OPTIONAL, -- Need M |
| measGapConfig | MeasGapConfig | OPTIONAL, -- Need M |
| measGapSharingConfig | MeasGapSharingConfig | OPTIONAL, -- Need M |

```
  ...,
  [[
```

| | | |
|---|---|---|
| interFrequencyConfig-NoGap-r16 | ENUMERATED {true} | OPTIONAL -- Need R |

]]
}

MeasObjectToAddModList may include MeasObjectNR, and MeasObjectNR may have the format of ASN.1 as shown in Table 2 below.

TABLE 2

| MeasObjectNR ::= | SEQUENCE { | |
|---|---|---|
| ssbFrequency | ARFCN-ValueNR | OPTIONAL, -- Cond SSBorAssociated |

SSB

| | | |
|---|---|---|
| ssbSubcarrierSpacing | SubcarrierSpacing | OPTIONAL, -- Cond SSBorAssociate |

dSSB

| smtc1 | SSB-MTC | OPTIONAL, -- Cond SSBorAssociatedSSB |
|---|---|---|
| smtc2 | SSB-MTC2 | |
| refFreqCSI-RS | ARFCN-ValueNR | OPTIONAL, -- Cond CSI-RS |
| referenceSignalConfig | ReferenceSignalConfig, | |
| absThreshSS-BlocksConsolidation | ThresholdNR | OPTIONAL, -- Need R |
| absThreshCSI-RS-Consolidation | ThresholdNR | OPTIONAL, -- Need R |
| nrofSS-BlocksToAverage | INTEGER (2..maxNrofSS-BlocksToAverage) | OPTIONAL, -- Need |

R

| | |
|---|---|
| nrofCSI-RS-ResourcesToAverage | INTEGER (2..maxNrofCSI-RS-ResourcesToAverage) OPTIONAL, |

-- Need R

| quantityConfigIndex | INTEGER (1..maxNrofQuantityConfig), | |
|---|---|---|
| offsetMO | Q-OffsetRangeList, | |
| cellsToRemoveList | PCI-List | OPTIONAL, -- Need N |
| cellsToAddModList | CellsToAddModList | OPTIONAL, -- Need N |
| excludedCellsToRemoveList | PCI-RangeIndexList | OPTIONAL, -- Need N |
| excludedCellsToAddModList | SEQUENCE (SIZE (1..maxNrofPCI-Ranges)) OF | OPTIO |
| | PCI-RangeElement | |

NAL, -- Need N

| | | |
|---|---|---|
| allowedCellsToRemoveList | PCI-RangeIndexList | OPTIONAL, -- Need N |
| allowedCellsToAddModList | SEQUENCE (SIZE (1..maxNrofPCI-Ranges)) OF | OPTION |
| | PCI-RangeElement | |

```
AL, -- Need N
  ...,
  [[
```

| | | |
|---|---|---|
| freqBandIndicatorNR | FreqBandIndicatorNR | OPTIONAL, -- Need R |
| measCycleSCell | ENUMERATED {sf160, sf512, sf256, sf320, sf640, | OPTIONAL -- N |

sf1024, sf1280}

```
ccd R
  ]],
  [[
```

| | | |
|---|---|---|
| smtc3list-r16 | SSB-MTC3List-r16 | OPTIONAL, -- Need R |
| rmtc-Config-r16 | SetupRelease {RMTC-Config-r16} | OPTIONAL, -- Need M |
| t312-r16 | SetupRelease { T312-r16 } | OPTIONAL -- Need M |

```
  ]],
  [[
```

| associatedMeasGapSSB-r17 | MeasGapId-r17 | OPTIONAL, -- Need R |
|---|---|---|
| associatedMeasGapCSIRS-r17 | MeasGapId-r17 | OPTIONAL, -- Need R |
| smtc4list-r17 | SSB-MTC4List-r17 | OPTIONAL, -- Need R |
| measCyclePSCell-r17 | ENUMERATED {ms160, ms256, ms320, ms512, ms640, ms1024, ms1280, spare1} | |
| | | OPTIONAL, -- Cond SCG |
| cellsToAddModListExt-v1710 | CellsToAddModListExt-v1710 | OPTIONAL -- Need N |

```
  ]],
  [[
```

| | | |
|---|---|---|
| associatedMeasGapSSB2-v1720 | MeasGapId-r17 | OPTIONAL, -- Cond AssociatedGa |

pSSB

| | | |
|---|---|---|
| associatedMeasGapCSIRS2-v1720 | MeasGapId-r17 | OPTIONAL -- CondAssociatedG |

apCSIRS
]]
}

| SSB-MTC3List-r16::= | SEQUENCE (SIZE(1..4)) OF SSB-MTC3-r16 | |
|---|---|---|
| SSB-MTC4List-r17::= | SEQUENCE (SIZE(1..3)) OF SSB-MTC4-r17 | |
| T312-r16 ::= | ENUMERATED { ms0, ms50, ms100, ms200, ms300, ms400, ms500, ms1000} | |
| ReferenceSignalConfig::= | SEQUENCE { | |
| ssb-ConfigMobility | SSB-ConfigMobility | OPTIONAL, -- Need M |
| csi-rs-ResourceConfigMobility | SetupRelease { CSI-RS-ResourceConfigMobility } | OPTIONAL -- Nee |

d M
}

| SSB-ConfigMobility ::= | SEQUENCE { | |
|---|---|---|
| ssb-ToMeasure | SetupRelease { SSB-ToMeasure } | OPTIONAL, -- Need M |
| deriveSSB-IndexFromCell | BOOLEAN, | |
| ss-RSSI-Measurement | SS-RSSI-Measurement | OPTIONAL, -- Need M |

```
  ...,
  [[
```

| | | |
|---|---|---|
| ssb-PositionQCL-Common-r16 | SSB-PositionQCL-Relation-r16 | OPTIONAL, -- Cond Sha |

redSpectrum

| | |
|---|---|
| ssb-PositionQCL-CellsToAddModList-r16 SSB-PositionQCL-CellsToAddModList-r16 | OPTIONAL, - |

- Need N

| | |
|---|---|
| ssb-PositionQCL-CellsToRemoveList-r16 PCI-List | OPTIONAL -- Need N |

```
  ]],
  [[
```

| | | |
|---|---|---|
| deriveSSB-IndexFromCellInter-r17 | ServCellIndex | OPTIONAL, -- Need R |
| ssb-PositionQCL-Common-r17 | SSB-PositionQCL-Relation-r17 | OPTIONAL, -- Cond Share |

dSpectrum2

| | | |
|---|---|---|
| ssb-PositionQCL-Cells-r17 | SetupRelease {SSB-PositionQCL-CellList-r17} | OPTIONAL -- Need |

```
M
  ]],
  [[
```

| | | |
|---|---|---|
| cca-CellsToAddModList-r17 | PCI-List | OPTIONAL, -- Need N |
| cca-CellsToRemoveList-r17 | PCI-List | OPTIONAL -- Need N |

```
  ]],
  [[
```

| | | |
|---|---|---|
| ssb-ToMeasureAltitudeBasedList-r18 | SetupRelease { | OPTIONAL -- Ne |

SSB-ToMeasureAltitudeBasedList-r18 }

ed M
]]
}
}

| | |
|---|---|
| Q-OffsetRangeList ::= | SEQUENCE { |
| rsrpOffsetSSB | Q-OffsetRange DEFAULT dB0, |
| rsrqOffsetSSB | Q-OffsetRange DEFAULT dB0, |
| sinrOffsetSSB | Q-OffsetRange DEFAULT dB0, |
| rsrpOffsetCSI-RS | Q-OffsetRange DEFAULT dB0, |
| rsrqOffsetCSI-RS | Q-OffsetRange DEFAULT dB0, |
| sinrOffsetCSI-RS | Q-OffsetRange DEFAULT dB0 |

}

| ThresholdNR ::= | SEQUENCE{ | |
|---|---|---|
| thresholdRSRP | RSRP-Range | OPTIONAL, -- Need R |
| thresholdRSRQ | RSRQ-Range | OPTIONAL, -- Need R |
| thresholdSINR | SINR-Range | OPTIONAL -- Need R |

}

| | |
|---|---|
| CellsToAddModList ::= | SEQUENCE (SIZE (1..maxNrofCellMeas)) OF CellsToAddMod |
| CellsToAddModListExt-v1710 ::= | SEQUENCE (SIZE (1..maxNrofCellMeas)) OF CellsToAddModExt-v1710 |
| CellsToAddMod ::= | SEQUENCE { |
| physCellId | PhysCellId, |
| cellIndividualOffset | Q-OffsetRangeList |

}

| CellsToAddModExt-v1710 ::= | SEQUENCE { | |
|---|---|---|
| ntn-PolarizationDL-r17 | ENUMERATED {rhcp,lhcp,linear} | OPTIONAL, -- Need R |
| ntn-PolarizationUL-r17 | ENUMERATED {rhcp,lhcp,linear} | OPTIONAL -- Need R |

}

| RMTC-Config-r16 ::= | SEQUENCE { | |
|---|---|---|
| rmtc-Periodicity-r16 | ENUMERATED {ms40, ms80, ms160, ms320, ms640}, | |
| rmtc-SubframeOffset-r16 | INTEGER(0..639) | OPTIONAL, -- Need M |

| | |
|---|---|
| measDurationSymbols-r16 | ENUMERATED {sym1, sym14or12, sym28or24, sym42or36, sym 70or60}, |
| rmtc-Frequency-r16 | ARFCN-ValueNR, |
| ref-SCS-CP-r16 | ENUMERATED {kHz15, kHz30, kHz60-NCP, kHz60-ECP}, |

```
  ...,
  [[
```

| | | |
|---|---|---|
| rmtc-Bandwidth-r17 | ENUMERATED {mhz100, mhz400, mhz800, mhz1600, | OPTIONAL, |
| | mhz2000} OPTIONAL, | |

- Need R

| | | |
|---|---|---|
| measDurationSymbols-v1700 | ENUMERATED {sym140, sym560, sym1120} | OPTIONAL, -- |

Need R

| | | |
|---|---|---|
| ref-SCS-CP-v1700 | ENUMERATED {kHz120, kHz480, kHz960} | OPTIONAL, -- Need |

R

| tci-StateInfo-r17 | SEQUENCE { | |
|---|---|---|
| tci-StateId-r17 | TCI-StateId, | |
| ref-ServCellId-r17 | ServCellIndex | OPTIONAL -- Need R |

```
  } OPTIONAL -- Need R
  ]],
  [[
```

| | | |
|---|---|---|
| ref-BWPId-r17 | BWP-Id | OPTIONAL -- Need R |

]]
}
SSB-PositionQCL-CellsToAddModList-r16 ::= SEQUENCE (SIZE (1..maxNrofCellMeas)) OF SSB-PositionQCL-Cells
ToAddMod-r16
SSB-PositionQCL-CellsToAddMod-r16 ::= SEQUENCE {

| | |
|---|---|
| physCellId-r16 | PhysCellId, |
| ssb-PositionQCL-r16 | SSB-PositionQCL-Relation-r16 |

}
SSB-PositionQCL-CellList-r17 ::= SEQUENCE (SIZE (1..maxNrofCellMeas)) OF SSB-PositionQCL-Cell-r17

| | |
|---|---|
| SSB-PositionQCL-Cell-r17 | ::= SEQUENCE { |
| physCellId-r17 | PhysCellId, |
| ssb-PositionQCL-r17 | SSB-PositionQCL-Relation-r17 |

}
SSB-ToMeasureAltitudeBasedList-r18 ::= SEQUENCE (SIZE (1..maxNrofAltitudeRanges-r18)) OF SSB-ToMeasureAlti
tudeBased-r18
SSB-ToMeasureAltitudeBased-r18 ::= SEQUENCE {

| | |
|---|---|
| altitudeRange-r18 | SEQUENCE { |
| altitudeMin-r18 | Altitude-r18 OPTIONAL, |
| altitudeMax-r18 | Altitude-r18 OPTIONAL, |
| altitudeHyst-r18 | HysteresisAltitude-r18 OPTIONAL |

},

| | |
|---|---|
| ssb-ToMeasure-r18 | SSB-ToMeasure |

}

Predetermined MeasObjectNR may include ssb-ToMeasure AltitudeBasedList. SSB-ToMeasureAltitudeBasedList may include one or a plurality of SSB-ToMeasureAltitudeBased, and each SSB-ToMeasureAltitudeBased may include the following information.
altitudeRange: values indicating an altitude range may be configured. For example, at least one of altitudeMin, altitudeMax, and altitudeHyst may be included.
altitudeMin means a minimum altitude and may express an altitude in unit of meters. At this time, altitudeMin expresses an altitude relative to sea level, and thus when a value of altitudeMin is not included, a minimum altitude value may be −420 m (or one of minimum altitude values that can be configured by the BS (for example, minAltitude)). That is, when the value of altitueMin is not included, the minimum altitude may be −420 m (or one of the minimum altitude values that can be configured (for example, miniAltitude)) rather than 0 m. For reference, through altitudeMin, one altitude value from −420 m (or one of the minimum altitude values that can be configured (for example, minAltitude)) to 10,000 m (or one of the maximum altitude values that can be configured (for example, maxAltitude)) may be indicated, in which case the granularity may be 1j or 2 m. For example, when the granularity is 1 j, one altitude value of [−420, −419, −418, . . . , 9999, 10000] may be expressed in units of 1 j, and when the granularity is 2 m, one altitude value of [−420, −418, −416, . . . , 9998, 10000] may be expressed in units of 2 m.
altitudeMax means a maximum altitude and may express an altitude in unit of meters. At this time, altitudeMax expresses an altitude relative to sea level, and thus when a value of altitudeMax is not included, a maximum altitude may be 10,000m or one of maximum altitude values that can be configured by the BS (for example, maxAltitude) rather than indicating infinity in the disclosure. For reference, through altitudeMax, one altitude value from −420 m (or one of the minimum altitude values that can be configured (for example, minAltitude)) to 10,000 m (or one of the maximum altitude values that can be configured (for example, maxAltitude)) may be indicated, in which case the granularity may be 1 j or 2 m. For example, when the granularity is 1 j, one altitude value of [−420, −419, −418, . . . , 9999, 10000] may be expressed in units of 1 j, and when the granularity is 2 m, one altitude value of [−420, −418, −416, . . . , 9998, 10000] may be expressed in units of 2 m

=altitudeHyst means a hysteresis value used when an altitude range is determined and may express a value in units of meters. For reference, through altitudeHyst, one hysteresis value from 0 m to 64 m (for example, 0, 1, 2, . . . , 63, and 64) may be indicated, and the granularity may be 1 j. For example, when an altitudeHyst value is not included, altitudeHyst may be a maximum value (that is, 0 m) that can be configured as altitudeHyst. For reference, altitudeHyst may be two that can be independently configured.
ssb-ToMeasure-r18: may be configured as a value indicating a pattern (set) of SSBs which the UAV UE may apply to altitudeRange. When ssb-ToMeasure-r18 is not configured, the UE may measure on all SSBs. Specifically, when ssb-ToMeasure-r18 is configured, it may mean a format of ASN.1 and a pattern of SSBs as shown in Table 3 and Table 4 below.

TABLE 3
- SSB-ToMeasure
The IE SSB-ToMeasure is used to configure a pattern of SSBs. For operation with shared spectrum channel
access in FRI, only mediumBitmap is used, and for FR2-2, longBitmap is used.

SSB-ToMeasure information element

-- ASNISTART
-- TAG-SSB-TOMEASURE-START

| | |
|---|---|
| SSB-ToMeasure ::= | CHOICE { |
| shortBitmap | BIT STRING (SIZE (4)), |
| mediumBitmap | BIT STRING (SIZE (8)), |
| longBitmap | BIT STRING (SIZE (64)) |

}
-- TAG-SSB-TOMEASURE-STOP
-- ASNISTOP

TABLE 4
SSB-ToMeasure field descriptions
long Bitmap
Bitmap when maximum number of SS/PBCH blocks per half frame equals to 64 as defined in TS
38.213 [13], clause 4.1. For operation with shared spectrum channel access in FR2-2, if the k-th bit
is set to 1, the UE assumes that one or more SS/PBCH blocks within the SMTC measurement duration
with candidate SS/PBCH block indexes corresponding to SS/PBCH block index equal to (k- 1) may
be transmitted; if the k-th bit is set to 0, the UE assumes that the corresponding SS/PBCH block(s)
are not transmitted.
mediumBitmap
Bitmap when maximum number of SS/PBCH blocks per half frame equals to 8 as defined in TS
38.213 [13], clause 4.1. For operation with shared spectrum channel access, if the k-th bit is set to 1,
the UE assumes that one or more SS/PBCH blocks within the SMTC measurement duration with
candidate SS/PBCH block indexes corresponding to SS/PBCH block index equal to k - 1 may be
transmitted; if the kt-th bit is set to 0, the UE assumes that the corresponding SS/PBCH block(s) are
not transmitted. The k-th bit is set to 0, where k > ssb-PositionQCL-Common and the number of
actually transmitted SS/PBCH blocks is not larger than the number of 1's in the bitmap. If ssb-
PositionQCL is configured with a value smaller than ssb-PositionQCL-Common, only the leftmost
K bits (K = ssb-PositionQCL) are applicable for the corresponding cell.
shortBitmap
Bitmap when maximum number of SS/PBCH blocks per half frame equals to 4 as defined in TS
38.213 [13], clause 4.1.

ReportConfigToAddModLis may include one or a plurality of ReportConfigNR, and each ReportConfigNR may have a format of ASN,1 as shown in Table 5 below.

TABLE 5

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17 |

}
}

| | |
|---|---|
| ReportCGI ::= | SEQUENCE { |
| cellForWhichToReportCGI | PhysCellId, |

```
    ...,
  [[
```

| | | |
|---|---|---|
| useAutonomousGaps-r16 | ENUMERATED {setup} | OPTIONAL -- Need R |

]]
}

| | |
|---|---|
| ReportSFTD-NR ::= | SEQUENCE { |
| reportSFTD-Meas | BOOLEAN, |
| reportRSRP | BOOLEAN, |

```
  ...,
  [[
```

| | | |
|---|---|---|
| reportSFTD-NeighMeas | ENUMERATED {true} | OPTIONAL, -- Need R |
| drx-SFTD-NeighMeas | ENUMERATED {true} | OPTIONAL, -- Need R |
| cellsForWhichToReportSFTD | SEQUENCE (SIZE (1..maxCellSFTD)) OF PhysCellId | OPTIONAL -- Need R |

]]
}

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...,
```

| | |
|---|---|
| condEventA4-r17 | SEQUENCE { |
| a4-Threshold-r17 | MeasTriggerQuantity, |
| hysteresis-r17 | Hysteresis, |
| timeToTrigger-r17 | TimeToTrigger |

},

| | |
|---|---|
| condEventD1-r17 | SEQUENCE { |

```
      distance ThreshFromReference1-r17 INTEGER(0..65525),
      distance ThreshFromReference2-r17 INTEGER(0..65525),
```

| | |
|---|---|
| referenceLocation1-r17 | ReferenceLocation-r17, |
| referenceLocation2-r17 | ReferenceLocation-r17, |
| hysteresis-r17 | HysteresisLocation-r17, |
| timeToTrigger-r17 | TimeToTrigger |

},

| | |
|---|---|
| condEventT1-r17 | SEQUENCE { |
| t1-Threshold-r17 | INTEGER (0..549755813887), |
| duration-r17 | INTEGER (1..6000) |

```
    }
  },
```

| | |
|---|---|
| rsType-r16 | NR-RS-Type, |

...
}

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distance ThreshFromReference1-r17 | INTEGER(1..65525), |
| distance ThreshFromReference2-r17 | INTEGER(1..65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]]
  },
```

| rsType | NR-RS-Type, | |
|---|---|---|
| reportInterval | ReportInterval, | |
| reportAmount | ENUMERATED {r1, r2, r4, r8, r16, r32, r64, infinity}, | |
| reportQuantityCell | MeasReportQuantity, | |
| maxReportCells | INTEGER (1..maxCellReport), | |
| reportQuantityRS-Indexes | MeasReportQuantity | OPTIONAL, -- Need R |
| maxNrofRS-IndexesToReport | INTEGER (1..maxNrofIndexes ToReport) | OPTIONAL, -- |

Need R

| includeBeamMeasurements | BOOLEAN, | |
|---|---|---|
| reportAddNeighMeas | ENUMERATED {setup} | OPTIONAL, -- Need R |

```
  ...,
  [[
```

| | | |
|---|---|---|
| measRSSI-ReportConfig-r16 | MeasRSSI-ReportConfig-r16 | OPTIONAL, -- Need R |
| useT312-r16 | BOOLEAN | OPTIONAL, -- Need M |
| includeCommonLocationInfo-r16 | ENUMERATED {true} | OPTIONAL, -- Need |

R

| | | |
|---|---|---|
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Ne |

ed M

| | | |
|---|---|---|
| includeSensor-Meas-r16 | SetupRelease {Sensor-NameList-r16} | OPTIONAL -- Need |

```
M
  ]],
  [[
```

| | | |
|---|---|---|
| coarseLocationRequest-r17 | ENUMERATED {true} | OPTIONAL, -- Need R |
| reportQuantityRelay-r17 | SL-MeasReportQuantity-r16 | OPTIONAL -- Need R |

]]
}

| PeriodicalReportConfig ::= | SEQUENCE { | |
|---|---|---|
| rsType | NR-RS-Type, | |
| reportInterval | ReportInterval, | |
| reportAmount | ENUMERATED {r1, r2, r4, r8, r16, r32, r64, infinity}, | |
| reportQuantityCell | MeasReportQuantity, | |
| maxReportCells | INTEGER (1..maxCellReport), | |
| reportQuantityRS-Indexes | MeasReportQuantity | OPTIONAL, -- Need R |
| maxNrofRS-IndexesToReport | INTEGER (1..maxNrofIndexesToReport) | OPTIONAL, -- |

Need R

| | |
|---|---|
| includeBeamMeasurements | BOOLEAN, |
| useAllowedCellList | BOOLEAN, |

```
  ...,
  [[
```

| | | |
|---|---|---|
| measRSSI-ReportConfig-r16 | MeasRSSI-ReportConfig-r16 | OPTIONAL, -- Need R |
| includeCommonLocationInfo-r16 | ENUMERATED {true} | OPTIONAL, -- Need |

R

| | | |
|---|---|---|
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Ne |

ed M

| | | |
|---|---|---|
| includeSensor-Meas-r16 | SetupRelease {Sensor-NameList-r16} | OPTIONAL, -- Need |

M

| | | |
|---|---|---|
| ul-Delay ValueConfig-r16 | SetupRelease { UL-DelayValueConfig-r16 } | OPTIONAL, -- Nee |

d M

| | | |
|---|---|---|
| reportAddNeighMeas-r16 | ENUMERATED {setup} | OPTIONAL -- Need R |

```
  ]],
  [[
```

| | | |
|---|---|---|
| ul-ExcessDelayConfig-r17 | SetupRelease { UL-ExcessDelayConfig-r17 } | OPTIONAL, -- Ne |

ed M

| | | |
|---|---|---|
| coarseLocationRequest-r17 | ENUMERATED {true} | OPTIONAL, -- Need R |
| reportQuantityRelay-r17 | SL-MeasReportQuantity-r16 | OPTIONAL -- Need R |

]]
}

| | |
|---|---|
| NR-RS-Type ::= | ENUMERATED {ssb, csi-rs} |
| MeasTriggerQuantity ::= | CHOICE { |
| rsrp | RSRP-Range, |
| rsrq | RSRQ-Range, |
| sinr | SINR-Range |

}

| | |
|---|---|
| MeasTriggerQuantityOffset ::= | CHOICE { |
| rsrp | INTEGER (−30..30), |
| rsrq | INTEGER (−30..30), |
| sinr | INTEGER (−30..30) |

}

| | |
|---|---|
| MeasReportQuantity ::= | SEQUENCE { |
| rsrp | BOOLEAN, |
| rsrq | BOOLEAN, |
| sinr | BOOLEAN |

}

| MeasRSSI-ReportConfig-r16 ::= | SEQUENCE { | |
|---|---|---|
| channelOccupancyThreshold-r16 | RSSI-Range-r16 | OPTIONAL -- Need R |

}

| | |
|---|---|
| CLI-EventTriggerConfig-r16 ::= | SEQUENCE { |
| eventId-r16 | CHOICE { |
| eventI1-r16 | SEQUENCE { |
| il-Threshold-r16 | MeasTriggerQuantityCLI-r16, |
| reportOnLeave-r16 | BOOLEAN, |
| hysteresis-r16 | Hysteresis, |
| timeToTrigger-r16 | TimeToTrigger |

```
    },
  ...
  },
```

| | |
|---|---|
| reportInterval-r16 | ReportInterval, |
| reportAmount-r16 | ENUMERATED {r1, r2, r4, r8, r16, r32, r64, infinity}, |
| maxReportCLI-r16 | INTEGER (1..maxCLI-Report-r16), |

...
}

| | |
|---|---|
| CLI-PeriodicalReportConfig-r16 ::= | SEQUENCE { |
| reportInterval-r16 | ReportInterval, |
| reportAmount-r16 | ENUMERATED {r1, r2, r4, r8, r16, r32, r64, infinity}, |
| reportQuantityCLI-r16 | MeasReportQuantityCLI-r16, |
| maxReportCLI-r16 | INTEGER (1..maxCLI-Report-r16), |

...
}

| RxTxPeriodical-r17 ::= | SEQUENCE { | |
|---|---|---|
| rxTxReportInterval-r17 | RxTxReportInterval-r17 | OPTIONAL, -- Need R |

| | |
|---|---|
| reportAmount-r17 | ENUMERATED {r1, infinity, spare6, spare5, spare4, spare3, spare2, spare1}, |

...
}
RxTxReportInterval-r17 ::= ENUMERATED {ms80,ms120,ms160,ms240,ms320,ms480,ms640,ms1024,ms1280,ms2048
,ms2560,ms5120,spare4,spare3,spare2,spare1}

| | |
|---|---|
| MeasTriggerQuantityCLI-r16 ::= | CHOICE { |
| srs-RSRP-r16 | SRS-RSRP-Range-r16, |
| cli-RSSI-r16 | CLI-RSSI-Range-r16 |

}

| | |
|---|---|
| MeasReportQuantityCLI-r16 ::= | ENUMERATED {srs-rsrp, cli-rssi} |
| ReportConfigInterRAT ::= | SEQUENCE { |
| reportType | CHOICE { |
| periodical | PeriodicalReportConfigInterRAT, |
| eventTriggered | EventTriggerConfigInterRAT, |
| reportCGI | ReportCGI-EUTRA, |

...,

| | |
|---|---|
| reportSFTD | ReportSFTD-EUTRA |

```
  }
  }
```

| | |
|---|---|
| ReportCGI-EUTRA ::= | SEQUENCE { |
| cellFor Which ToReportCGI | EUTRA-PhysCellId, |

```
  ...,
  [[
```

| | | |
|---|---|---|
| useAutonomousGaps-r16 | ENUMERATED {setup} | OPTIONAL -- Need R |

]]
}

| | |
|---|---|
| ReportSFTD-EUTRA ::= | SEQUENCE { |
| reportSFTD-Meas | BOOLEAN, |
| reportRSRP | BOOLEAN, |

...
}

| | |
|---|---|
| EventTriggerConfigInterRAT ::= | SEQUENCE { |
| eventId | CHOICE { |
| eventB1 | SEQUENCE { |
| b1-ThresholdEUTRA | MeasTriggerQuantityEUTRA, |
| reportOnLeave | BOOLEAN, |
| hysteresis | Hysteresis, |
| timeToTrigger | TimeToTrigger, |

```
      ...
    },
```

| | |
|---|---|
| eventB2 | SEQUENCE { |
| b2-Threshold1 | MeasTriggerQuantity, |
| b2-Threshold2EUTRA | MeasTriggerQuantityEUTRA, |
| reportOnLeave | BOOLEAN, |
| hysteresis | Hysteresis, |
| timeToTrigger | TimeToTrigger, |

```
      ...
    },
    ...,
    [[
```

| | |
|---|---|
| eventB1-UTRA-FDD-r16 | SEQUENCE { |
| b1-ThresholdUTRA-FDD-r16 | MeasTriggerQuantity UTRA-FDD-r16, |
| reportOnLeave-r16 | BOOLEAN, |
| hysteresis-r16 | Hysteresis, |
| timeToTrigger-r16 | TimeToTrigger, |
| ... | |

},

| | |
|---|---|
| eventB2-UTRA-FDD-r16 | SEQUENCE { |
| b2-Threshold1-r16 | MeasTriggerQuantity, |
| b2-Threshold2UTRA-FDD-r16 | MeasTriggerQuantityUTRA-FDD-r16, |
| reportOnLeave-r16 | BOOLEAN, |
| hysteresis-r16 | Hysteresis, |
| timeToTrigger-r16 | TimeToTrigger, |

```
      ...
    }
    ]],
    [[
```

| | |
|---|---|
| eventY1-Relay-r17 | SEQUENCE { |
| y1-Threshold1-r17 | MeasTriggerQuantity, |
| y1-Threshold2-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger, |

```
      ...
    },
```

| | |
|---|---|
| eventY2-Relay-r17 | SEQUENCE { |
| y2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger, |

```
      ...
    }
    ]]
  },
```

| | |
|---|---|
| rsType | NR-RS-Type, |
| reportInterval | ReportInterval, |
| reportAmount | ENUMERATED {r1, r2, r4, r8, r16, r32, r64, infinity}, |
| reportQuantity | MeasReportQuantity, |
| maxReportCells | INTEGER (1..maxCellReport), |

...,
[[

| | | |
|---|---|---|
| reportQuantityUTRA-FDD-r16 | MeasReportQuantity UTRA-FDD-r16 | OPTIONAL -- Need R |

```
  ]],
  [[
```

| | | |
|---|---|---|
| includeCommonLocationInfo-r16 | ENUMERATED {true} | OPTIONAL, -- Need R |
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Need M |
| includeSensor-Meas-r16 | SetupRelease {Sensor-NameList-r16} | OPTIONAL -- Need M |

```
  ]],
  [
```

| | | |
|---|---|---|
| reportQuantityRelay-r17 | SL-MeasReportQuantity-r16 | OPTIONAL -- Need R |

]]}

| | |
|---|---|
| PeriodicalReportConfigInterRAT ::= | SEQUENCE { |
| reportInterval | ReportInterval, |
| reportAmount | ENUMERATED {r1, r2, r4, r8, r16, r32, r64, infinity}, |
| reportQuantity | MeasReportQuantity, |
| maxReportCells | INTEGER (1..maxCellReport), |

```
  ...,
  [[
```

| | | |
|---|---|---|
| reportQuantityUTRA-FDD-r16 | MeasReportQuantityUTRA-FDD-r16 | OPTIONAL -- Need R |

```
  ]],
  [[
```

| | | |
|---|---|---|
| includeCommonLocationInfo-r16 | ENUMERATED {true} | OPTIONAL, -- Need R |
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Need M |
| includeSensor-Meas-r16 | SetupRelease {Sensor-NameList-r16} | OPTIONAL -- Need M |

```
  ]],
  [[
```

| | | |
|---|---|---|
| reportQuantityRelay-r17 | SL-MeasReportQuantity-r16 | OPTIONAL -- Need R |

]]
}

| | |
|---|---|
| MeasTriggerQuantityUTRA-FDD-r16 ::= | CHOICE{ |
| utra-FDD-RSCP-r16 | INTEGER (−5..91), |
| utra-FDD-EcNO-r16 | INTEGER (0..49) |

}

| | |
|---|---|
| MeasReportQuantityUTRA-FDD-r16 ::= | SEQUENCE { |
| cpich-RSCP | BOOLEAN, |
| cpich-EcN0 | BOOLEAN |

}

For convenience of description, the disclosure is described based on that reportType of ReportConfigNR is configured as eventTriggered, and eventId of EventTriggerConfig in eventTriggered is configured as eventA4. Of course, the following description may be equally applied to other event conditions (for example, eventA3, condEventA3, condEventA4, eventA5, and condEventA5). The event A4 may be an event indicating that neighboring cells are better than a threshold value (Neighbor becomes better than threshold), and detailed description is made below. For example, in the disclosure, a single a4-Threshold may be configured for the Event A4, and MeasTriggerQuantity configured as a4-Threshold may be one of reference signal received power (rsrp) (RSRP-Range), reference signal received quality (rsrq) (RSRQ-Range), and signal-to-interference-plus-noise ratio (sinr) (SINR-Range).

5.5.4.5Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

### Inequality A4-1 (Entering Condition)

$$Mn + Ofn + Ocn - Hys > Thresh$$

### Inequality A4-2 (Leaving Condition)

$$Mn + Ofn + Ocn + Hys < Thresh$$

The variables in the formula are defined as follows:

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys is the hysteresis parameter for this event (i.e. hysteresis as defined within reportConfigNR for this event).

Thresh is the threshold parameter for this event (i.e. a4-Threshold as defined within reportConfigNR for this event).

Mn is expressed in dBm in case of RSRP, or in dB in case of RSRQ and RS-SINR.

Ofn, Ocn, Hys are expressed in dB.

Thresh is expressed in the same unit as Mn.

NOTE: The definition of Event A4 also applies to CondEvent A4.

In operation 1e-20, the UE 1e-01 may perform SSB measurement, based on the measurement configuration information received in operation 1e-15. At this time, when ssb-ToMeasureAltitudeBasedList is configured in specific MeasObjectNR, the UE 1e-01 may measure SSBs by applying ssb-ToMeasure-r18 configured in the corresponding altitude range area when flying in the altitude range area indicated by ssb-ToMeasureAltitudeBasedList. For reference, when ssb-ToMeasure-r18 is not configured in the corresponding altitude range area, the UE 1e-01 may measure on all SSBs. Otherwise (that is, when flying at altitudes other than the altitude range area indicated by ssb-ToMeasureAltitudeBasedList or when flying in altitude range areas in which ssb-ToMeasure-r18 is not configured), the UE 1e-01 may measure on SSBs by applying ssb-ToMeasure (without suffix). For reference, when ssb-ToMeasure (without suffix) is not configured, the UE 1e-01 may measure all SSBs. At least one of the following methods (that is, a combination of the methods or only one method) may be proposed as a method of determining that the UE 1e-01 is flying in the altitude range area indicated by SSB-ToMeasureAltitudeBased.
Method 1: when only altitudeMin is configured among altitudeMin, altitudeMax, and altitudeHyst, the UE 1e-01 may measure SSBs by applying ssb-ToMeasure-r18 configured in the corresponding SSB-ToMeasureAltitudeBased if the UE flies higher than altitudeMin or flies at altitudeMin (UE altitude≥altitudeMin) (the UE 1e-01 may measure all SSBs when ssb-ToMeasure-r18 is not configured).
Method 2: when only altitudeMax is configured among altitudeMin, altitudeMax, and altitudeHyst, the UE 1e-01 may measure SSBs by applying ssb-ToMeasure-r18 configured in the corresponding SSB-ToMeasureAltitudeBased if the UE flies lower than altitudeMax or flies at altitudeMax (UE altitude≤altitudeMax) (the UE 1e-01 may measure all SSBs when ssb-ToMeasure-r18 is not configured).
Method 3: when only altitudeMin and altitudeMax are configured among altitudeMin, altitudeMax, and altitudeHyst, the UE 1e-01 may measure SSBs by applying ssb-ToMeasure-r18 configured in the corresponding SSB-ToMeasureAltitudeBased if the UE flies at altitudeMin or altitudeMax or flies higher than altitudeMin and lower than altitudeMax (altitudeMin≤UE altitude≤altitudeMax) (the UE 1e-01 may measure all SSBs when ssb-ToMeasure-r18 is not configured).
Method 4: when only altitudeMin and altitudeHyst are configured among altitudeMin, altitudeMax, and altitudeHyst, the UE 1e-01 may measure SSBs by applying ssb-ToMeasure-r18 configured in the corresponding SSB-ToMeasure AltitudeBased if the UE flies higher than altitudeMin or flies at altitudeMin (UE altitude≥altitudeMin) (the UE 1e-01 may measure all SSBs when ssb-ToMeasure-r18 is not configured). When the following condition is satisfied according to the applied SSB pattern, the UE 1e-01 may measure SSBs.
UE altitude≥max (−420, altitudeMin-altitudeHyst) or UE altitude≥altitudeMin-altitudeHyst

Accordingly, when flying higher than altitudeMin or flying at altitudeMin, the UE 1e-01 may measure SSBs by directly applying ssb-ToMeasure-r18 configured in the corresponding SSB-ToMeasureAltitudeBased (the UE 1e-01 may measure all SSBs when ssb-ToMeasure-r18 is not configured), and has an advantage of measuring SSBs according to pre-applied SSB patterns when the UE does not fly lower than max (−420, altitudeMin-altitudeHst) even though flying lower than altitudeMin in the future.
Method 5: when only altitudeMax and altitudeHyst are configured among altitudeMin, altitudeMax, and altitudeHyst, the UE 1e-01 may measure SSBs by applying ssb-ToMeasure-r18 configured in the corresponding SSB-ToMeasure AltitudeBased if the UE flies lower than altitudeMax or flies at altitudeMax (UE altitude≤altitudeMax) (the UE 1e-01 may measure all SSBs when ssb-ToMeasure-r18 is not configured). When the following condition is met according to the applied SSB pattern, the UE 1e-01 may measure SSBs.
UE altitude≤min (10000, altitudeMax+altitudeHyst) or UE altitude≤ altitudeMax+altitudeHyst

Accordingly, when flying lower than altitudeMax or flying at altitudeMax, the UE 1e-01 may measure SSBs by directly applying ssb-ToMeasure-r18 configured in the corresponding SSB-ToMeasureAltitudeBased (the UE 1e-01 may measure all SSBs when ssb-ToMeasure-r18 is not configured), and has an advantage of measuring SSBs according to pre-applied SSB patterns when the UE does not fly higher than min (10000, altitudeMax+altitudeHyst) even though flying higher than altitudeMax in the future.
Method 6: when only altitudeMin and altitudeHyst are configured among altitudeMin, altitudeMax, and altitudeHyst, the UE 1e-01 may measure SSBs by applying ssb-ToMeasure-r18 configured in the corresponding SSB-ToMeasure AltitudeBased if the UE flies higher than altitudeMin+altitudeHyst or flies at altitudeMin+altitudeHyst (UE altitude≥altitudeMin+altitudeHyst) (the UE 1e-01 may measure all SSBs when ssb-ToMeasure-r18 is not configured). When the following condition is satisfied according to the applied SSB pattern, the UE 1e-01 may measure SSBs.
UE altitude≥altitudeMin

Accordingly, when flying higher than altitudeMin+altitudeHyst or flying at altitudeMin+altitudeHyst, the UE 1e-01 may measure SSBs by applying ssb-ToMeasure-r18 configured in the corresponding SSB-ToMeasureAltitudeBased (the UE 1e-01 may measure all SSBs when ssb-ToMeasure-r18 is not configured), and has an advantage of measuring SSBs according to pre-applied SSB patterns when the UE does not fly lower than altitudeMin even though flying lower than altitudeMin+altitudeHyst in the future. That is, when the UE 1e-01 flies at altitudeMin and then flies lower than altitudeMin repeatedly, there is an advantage in that it does not need to perform SSB measurement while unnecessarily changing the SSB pattern.
Method 7: when only altitudeMax and altitudeHyst are configured among altitudeMin, altitudeMax, and altitudeHyst, the UE 1e-01 may measure SSBs by applying ssb-ToMeasure-r18 configured in the corresponding SSB-ToMeasureAltitudeBased if the UE flies lower than altitudeMax-altitudeHyst or flies at altitudeMax-altitudeHyst (UE altitude≤altitudeMax-altitudeHyst) (the UE 1e-01 may measure all SSBs when ssb-ToMeasure-r18 is not configured). When the following condition is satisfied according to the applied SSB pattern, the UE 1e-01 may measure SSBs.
UE altitude≤altitudeMax

Accordingly, when flying lower than altitudeMax-altitudeHyst or flying at altitudeMax-altitudeHyst, the UE 1e-01 may measure SSBs by directly applying ssb-ToMeasure-r18 configured in the corresponding SSB-ToMeasureAltitudeBased (the UE 1e-01 may measure all SSBs when ssb-ToMeasure-r18 is not configured), and has an advantage of measuring SSBs according to pre-applied SSB patterns when the UE does not fly higher than altitudeMax even though flying higher than altitudeMax-altitudeHyst in the future. That is, when the UE 1e-01 flies at altitudeMax and then flies higher than altitudeMax repeatedly, there is an advantage in that it does not need to perform SSB measurement while unnecessarily changing the SSB pattern.
Method 8: when all of altitudeMin, altitudeMax, and altitudeHyst are configured among altitudeMin, altitudeMax, and altitudeHyst, the UE 1e-01 may measure on SSBs by applying ssb-ToMeasure-r18 configured in the corresponding SSB-ToMeasureAltitudeBased if the UE flies at altitudeMin or altitudeMax or flies higher than altitudeMin and lower than altitudeMax (altitudeMin≤UE altitude≤ altitudeMax) (the UE 1e-01 may measure all SSBs when ssb-ToMeasure-r18 is not configured). When the following condition is satisfied in the future, the UE 1e-01 may measure on SSBs according to pre-applied SSB patterns.
altitudeMin-altitudeHyst≤UE altitude≤altitudeMax+altitudeHyst or max (−420, altitudeMin-altitudeHyst)≤UE altitude≤min (10000, altitudeMax+altitudeHyst)

For example, when flying lower than altitudeMin-altitudeHyst or higher than altitudeMax+altitudeHyst, the UE 1e-01 may measure SSBs according to SSB patterns that can be applied to the corresponding altitude range area without following the applied SSB patterns.
Method 9: when all of altitudeMin, altitudeMax, and altitudeHyst are configured among altitudeMin, altitudeMax, and altitudeHyst, the UE 1e-01 may measure SSBs by applying ssb-ToMeasure-r18 configured in the corresponding SSB-ToMeasureAltitudeBased if the UE flies at altitudeMin+altitudeHyst or altitudeMax-altitudeHys or flies higher than altitudeMin+altitudeHyst and lower than altitudeMax−altitudeHyst (altitudeMin+altitudeHyst≤UE altitude≤altitudeMax-altitudeHyst) (the UE 1e-01 may measure all SSBs when ssb-ToMeasure-r18 is not configured). When the following condition is satisfied in the future, the UE 1e-01 may measure SSBs according to the pre-applied SSB patterns.
altitudeMin≤UE altitude≤altitudeMax

For example, when flying lower than altitudeMin or higher than altitudeMax, the UE 1e-01 may measure SSBs according to SSB patterns that can be applied to the corresponding altitude range area without following the applied SSB patterns.

For reference, one altitudeHyst has been described above for convenience of description, but altitudeHyst applied to altitudeMin and altitudeHyst applied to altitudeMax may be separately used. For example, in the above equation, hysteresis applied to altitudeMin may be altitudeHystMin (when configured by the gNB 1e-02), and hysteresis applied to altitudeMax may be altitudeHystMax (when configured by the gNB 1e-02). The UE 1e-01 may perform Layer 3 filter as follows.

### 5.5.3.2Layer 3 Filtering

The UE shall:
1> for each cell measurement quantity, each beam measurement quantity, each sidelink measurement quantity as needed in clause 5.8.10, for each CLI measurement quantity that the UE performs measurements according to 5.5.3.1, and for each candidate L2 U2N Relay UE measurement quantity according to 5.5.3.4:
   2> filter the measured result, before using for evaluation of reporting criteria or for measurement reporting, by the following formula:

$${F}_{n} = ( 1 - a ) * {F}_{n - 1} + a * {M}_{n}$$

where
Mₙ is the latest received measurement result from the physical layer;
Fₙ is the updated filtered measurement result, that is used for evaluation of reporting criteria or for measurement reporting;
Fₙ₋₁ is the old filtered measurement result, where F₀ is set to M₁ when the first measurement result from the physical layer is received; and for MeasObjectNR, a=½^{(ki/4)}, where kᵢ is the filterCoefficient for the corresponding measurement quantity of the i:th QuantityConfigNR in quantityConfigNR-List, and i is indicated by quantityConfigIndex in MeasObjectNR; for other measurements, a=½^{(k/4)}, where k is the filterCoefficient for the corresponding measurement quantity received by the quantityConfig; for UTRA-FDD, a=½^{(k/4)}, where k is the filterCoefficient for the corresponding measurement quantity received by quantityConfigUTRA-FDD in the QuantityConfig;
   2> adapt the filter such that the time characteristics of the filter are preserved at different input rates, observing that the filterCoefficient k assumes a sample rate equal to X ms; The value of X is equivalent to one intra-frequency L1 measurement period as defined in TS 38.133 assuming non-DRX operation, and depends on frequency range.

The UE 1e-01 may derive each of the Layer 3 filtered cell measurement result and Layer 3 filtered beam measurement result according to the following procedure.

### 5.5.3.3Derivation of Cell Measurement Results

The network may configure the UE in RRC_CONNECTED to derive RSRP, RSRQ and SINR measurement results per cell associated to NR measurement objects based on parameters configured in the measObject (e.g., maximum number of beams to be averaged and beam consolidation thresholds) and in the reportConfig (rsType to be measured, SS/physical broadcast channel (PBCH) block or channel state information reference signal (CSI-RS)).

The UE shall:
1> for each cell measurement quantity to be derived based on SS/PBCH block:
   2> if nrofSS-BlocksToAverage is not configured in the associated measObject in RRC_CONNECTED or in the associated entry in measIdleCarrierListNR within VarMeasIdleConfig in RRC_IDLE/RRC_INACTIVE; or
   2> if absThreshSS-BlocksConsolidation is not configured in the associated measObject in RRC_CONNECTED or in the associated entry in measIdleCarrierListNR within VarMeasIdleConfig in RRC_IDLE/RRC_INACTIVE; or
   2> if the highest beam measurement quantity value is below or equal to absThreshSS-BlocksConsolidation:
      3> derive each cell measurement quantity based on SS/PBCH block as the highest beam measurement quantity value, where each beam measurement quantity is described in TS 38.215 [9];
   2> else:
      3> derive each cell measurement quantity based on SS/PBCH block as the linear power scale average of the highest beam measurement quantity values above absThreshSS-BlocksConsolidation where the total number of averaged beams shall not exceed nrofSS-BlocksToAverage, and where each beam measurement quantity is described in TS 38.215 [9];
   2> if in RRC_CONNECTED, apply layer 3 cell filtering as described in 5.5.3.2;
1> for each cell measurement quantity to be derived based on CSI-RS:
   2> consider a CSI-RS resource to be applicable for deriving cell measurements when the concerned CSI-RS resource is included in the csi-rs-CellMobility including the physCellId of the cell in the CSI-RS-Resource ConfigMobility in the associated measObject;
   2> if nrofCSI-RS-ResourcesToAverage in the associated measObject is not configured; or
   2> if absThreshCSI-RS-Consolidation in the associated measObject is not configured; or
   2> if the highest beam measurement quantity value is below or equal to absThreshCSI-RS-Consolidation:
      3> derive each cell measurement quantity based on applicable CSI-RS resources for the cell as the highest beam measurement quantity value, where each beam measurement quantity is described in TS 38.215 [9];
   2> else:
      3> derive each cell measurement quantity based on CSI-RS as the linear power scale average of the highest beam measurement quantity values above absThreshCSI-RS-Consolidation where the total number of averaged beams shall not exceed nrofCSI-RS-ResourcesToAverage;
   2> apply layer 3 cell filtering as described in 5.5.3.2.

### 5.5.3.3a Derivation of Layer 3 Beam Filtered Measurement

The UE shall:
1> for each layer 3 beam filtered measurement quantity to be derived based on SS/PBCH block;
   2> derive each configured beam measurement quantity based on SS/PBCH block as described in TS 38.215 [9], and apply layer 3 beam filtering as described in 5.5.3.2;
1> for each layer 3 beam filtered measurement quantity to be derived based on CSI-RS;
   2> derive each configured beam measurement quantity based on CSI-RS as described in TS 38.215 [9], and apply layer 3 beam filtering as described in 5.5.3.2.

In operation 1e-25, the UE 1e-01 may determine whether to trigger a measurement report, based on the measurement configuration information received in operation 1e-20. First, the UE 1e-01 may determine cells applied to eventA4 as follows according to whether useAllowedCellList is set to true in eventA4.
If useAllowedCellList is set to true, the UE 1e-01 may consider that any neighboring cell detected based on parameters in measObjectNR associated with measId can be applied among cells included in allowedCellsToAddModList defined by measId in VarMeasConfig (that is, measId that connects reportConfig configuring eventA4 and measObjectNR associated therewith).
If useAllowedCellList is not set to true (else), the UE 1e-01 may consider that any neighboring cell detected based on parameters in measObjectNR associated with measId can be applied when the concerned cell is not included in included in allowedCellsToAddModList defined by measId in VarMeasConfig (that is, measId that connects reportConfig configuring eventA4 and measObjectNR associated therewith).

The UE 1e-01 may determine whether there is a first cell in which the eventA4 satisfies the following entry condition in operation 1e-15.
When reportType is set to eventTriggered and the entry condition of eventA4 is satisfied, that is, when eventId of reportConfig within VarMeasConfig is eventA4, all measurements performing layer 3 filtering for one or a plurality of cells applied to the eventA4 satisfy the entering condition in operation 1e-15 during timeToTrigger defined by the event, and VarMeasReportList does not include a measurement reporting entry for measId associated with the event (measId being an identifier that connects a reporting configuration and a measurement object, and herein referring to measId that connects reportConfig and MeasObjectNR mapped thereto),

When the condition is satisfied, the UE 1e-01 may perform the following condition.
include a measurement reporting entry within the VarMeasReportList for this measId;
set the numberOfReportsSent defined within the VarMeasReportList for this measId to 0;
include the concerned cell(s) in the cellsTriggeredList defined within the VarMeasReportList for this measId;
if use T312 is set to true in reportConfig for this event:
if T310 for the corresponding special cell (SpCell) is running; and
if T312 is not running for corresponding SpCell:
start timer T312 for the corresponding SpCell with the value of T312 configured in the corresponding measObjectNR;
initiate the measurement reporting procedure, as specified in 1e-30;

Alternatively, the UE 1e-01 may determine whether there is a subsequent cell that satisfies the entry condition of the eventA4 in operation 1e-15.
When reportType is set to eventTriggered and the entry condition of eventA4 is satisfied, that is, when eventId of reportConfig within VarMeasConfig is eventA4 and all measurements performing layer 3 filtering for one or a plurality of applied cells which is not included in cellsTriggeredList satisfy the entering condition in operation 1e-15 during timeToTrigger defined by the event,

When the condition is satisfied, the UE 1e-01 may perform the following procedure.
set the numberOfReportsSent defined within the VarMeasReportList for this measId to 0;
include the concerned cell(s) in the cellsTriggeredList defined within the VarMeasReportList for this measId;
if use T312 is set to true in reportConfig for this event:
if T310 for the corresponding SpCell is running; and
if T312 is not running for corresponding SpCell:
start timer T312 for the corresponding SpCell with the value of
T312 configured in the corresponding measObjectNR;
initiate the measurement reporting procedure, as specified in 1e-30;

Alternatively, the UE 1e-01 may determine whether there are cells that satisfy the following leaving condition of evnetA4 in operation 1e-15.
When reportType is set to eventTriggered and the leaving condition of eventA4 is satisfied, that is, when eventId of reportConfig within VarMeasConfig is eventA4 and all measurements performing layer 3 filtering for one or a plurality of applied cells included in cellsTriggeredList satisfy the leaving condition in operation 1e-15 during timeToTrigger defined by the event,

When the condition is satisfied, the UE 1e-01 may perform the following procedure.
remove the concerned cell(s) in the cellsTriggeredList defined within the VarMeasReportList for this measId;
if reportOnLeave is set to true for the corresponding reporting configuration:
initiate the measurement reporting procedure, as specified in 1e-30;
if the cellsTriggeredList defined within the VarMeasReportList for this measId is empty:
remove the measurement reporting entry within the VarMeasReportList for this measId;
stop the periodical reporting timer for this measId, if running;

When a measurement reporting procedure is initiated in operation 1e-25, the UE 1e-01 may transmit a measurement result message (MeasurementReport) to the gNB 1e-02 according to the following procedure in operation 1e-30.

For the measId for which the measurement reporting procedure was triggered, the UE shall set the measResults within the MeasurementReport message as follows:
1> set the measId to the measurement identity that triggered the measurement reporting;
1> for each serving cell configured with serving CellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2:
   2> if the UE is in NE-DC and the measurement configuration that triggered this measurement report is associated with the master cell group (MCG):
      3> set the measResultServFreqListEUTRA-SCG to include an entry for each evolved universal terrestrial radio access (E-UTRA) secondary cell group (SCG) serving frequency with the following:
         4> include carrierFreq of the E-UTRA serving frequency;
         4> set the measResultServing Cell to include the available measurement quantities that the UE is configured to measure by the measurement configuration associated with the SCG;
         4> if reportConfig associated with the measId that triggered the measurement reporting includes reportAddNeighMeas:
         5> the measResultServFreqListNR-SCG to include with measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report; 4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if there is at least one applicable neighbouring cell or candidate L2 U2N Relay UE to report:
   2> if the reportType is set to eventTriggered or periodical:
      3> perform as follows:
         4> set the measResultNeighCells to include the best neighbouring cells up to maxReportCells in accordance with the following:
         5> if the reportType is set to eventTriggered and eventId is not set to eventD1:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasurementReport message via SRB1 embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.

The beam measurement result of clause 5.5.5.2 may be included in MeasurementReport by the UE 1e-01 according to the following procedure.

For beam measurement information to be included in a measurement report the UE shall:
1> if reportType is set to eventTriggered:
   2> consider the trigger quantity as the sorting quantity if available, otherwise RSRP as sorting quantity if available, otherwise RSRQ as sorting quantity if available, otherwise SINR as sorting quantity;
1> set rsIndexResults to include up to maxNrofRS-IndexesToReport SS/PBCH block indexes or CSI-RS indexes in order of decreasing sorting quantity as follows:
   2> if the measurement information to be included is based on SS/PBCH block:
      3> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
      3> if includeBeamMeasurements is set to true, include the SS/PBCH based measurement results for the quantities in reportQuantityRS-Indexes for each SS/PBCH block index;
   2> else if the beam measurement information to be included is based on CSI-RS:
      3> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
      3> if includeBeamMeasurements is set to true, include the CSI-RS based measurement results for the quantities in reportQuantityRS-Indexes for each CSI-RS index.

The cell measurement result of clause 5.5.5.3 may be included in MeasurementReport by the UE 1e-01 according to the following procedure.

The UE shall determine the sorting quantity according to parameters of the reportConfig associated with the measId that triggered the reporting:
1> if the reportType is set to eventTriggered:
   2> for an NR cell, consider the quantity used in the aN-Threshold (for eventA1, eventA2 and eventA4) or in the a5-Threshold2 (for eventA5) or in the aN-Offset (for eventA3 and eventA6) as the sorting quantity;

FIG. 1F is a flowchart illustrating a process in which an uncrewed aerial vehicle (UAV) UE transmits an event AxHy-based measurement result message to a gNB in a next-generation mobile communication system according to an embodiment of the disclosure.

The UAV UE may be a UE that is able to fly. Accordingly, the UAV UE has a characteristic of having a higher probability of line of sight than a terrestrial UE. Therefore, the UAV UE may have a disadvantage of receiving downlink (hereinafter, referred to as DL) interference from more cells compared to the terrestrial UE. That is, the UAV UE has a characteristic of receiving DL interference at a high level from more neighboring cells compared to the terrestrial UE. Similarly, the UAV UE has a characteristic of giving uplink (hereinafter, referred to as UL) to more cells compared to the terrestrial UE. Accordingly, a method by which the UAV UE reports MeasurementReport to the gNB when a predetermined event is satisfied in a predetermined altitude range area is proposed.

Referring to FIG. 1F, in operation 1f-05, a UAV UE 1f-01 may establish an RRC connection with an NR gNB 1f-02 to be in an RRC-connected mode (RRC_CONNECTED).

In operation 1f-10, the UAV UE 1f-01 may transmit a UE capability information message (UECapabilityInformation) to the gNB 1f-02. This may follow the above-described embodiment. In addition, the message may include capability information indicating whether the UE 1f-01 supports EventAxHy (for example, at least one of EventA3H1, EventA3H2, EventA4H1, EventA4H2, EventA5H1, and EventA5H2). Specifically, EventAxHy may be at least one of the following events.
Event A3H1: Neighbour becomes offset better than SpCell and the Aerial UE altitude becomes higher than a threshold.
Event A3H2: Neighbour becomes offset better than SpCell and the Aerial UE altitude becomes lower than a threshold.
Event A4H1: Neighbour becomes better than threshold1 and the Aerial UE altitude becomes higher than a threshold2.
Event A4H2: Neighbour becomes better than threshold1 and the Aerial UE altitude becomes lower than a threshold2.
Event A5H1: SpCell becomes worse than threshold1 and neighbour becomes better than threshold2 and the Aerial UE altitude becomes higher than a threshold3.
Event A5H2: SpCell becomes worse than threshold1 and neighbour becomes better than threshold2 and the Aerial UE altitude becomes lower than a threshold3.

For reference, capability information indicating whether the EventAxHy is supported may be indicated separately from EventHx (for example, at least one of EventH1 and EventH2) supporting UE capability or commonly with the same.
Event H1: Aerial UE altitude becomes higher than a threshold.
Event H2: Aerial UE altitude becomes lower than a threshold.

In operation 1f-15, the gNB 1f-02 may transmit a predetermined RRC message (for example, RRCReconfiguration) containing measurement configuration information (MeasConfig) to the UE 1f-01. This may follow the above-described embodiment. In addition, unlike the above-described embodiment, the gNB 1f-01 following the disclosure may configure eventAxHy in the UE 1f-01 through report configuration information (ReportConfigNR). For example, the gNB 1f-02 may configure, in the UE 1f-01, a report type (reportType) for each ReportConfigNR as one of eventA3H1, eventA3H2, eventA4H1, eventA4H2, eventA5H1, and eventA5H2, and a format of ASN.1 therefor is as shown in Table 6 below.

TABLE 6

| | |
|---|---|
| ReportConfigNR ::= | SEQUENCE { |
| reportType | CHOICE { |
| periodical | PeriodicalReportConfig, |
| eventTriggered | EventTriggerConfig, |

```
    ...,
    [omitted]
```

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1..65525), |
| distanceThreshFromReference2-r17 | INTEGER(1..65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]],
    [[
```

| | |
|---|---|
| eventH1-r18 | SEQUENCE { |
| h1-Threshold-r18 | Altitude-r18, |
| h1-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN |

},

| | |
|---|---|
| eventH2-r18 | SEQUENCE { |
| h2-Threshold-r18 | Altitude-r18, |
| h2-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN |

},

| | |
|---|---|
| eventA3H1-r18 | SEQUENCE { |
| a3-Offset-r18 | MeasTriggerQuantityOffset, |
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA3H2-r18 | SEQUENCE { |
| a3-Offset-r18 | MeasTriggerQuantityOffset, |
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

},

| | |
|---|---|
| eventA4H1-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA4H2-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

},

| | |
|---|---|
| eventA5H1-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA5H2-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

```
    }
    ]]
  },
  rsType NR-RS-Type,
```

| reportInterval | ReportInterval, | |
|---|---|---|
| reportAmount | ENUMERATED {r1, r2, r4, r8, r16, r32, r64, infinity}, | |
| reportQuantityCell | MeasReportQuantity, | |
| maxReportCells | INTEGER (1..maxCellReport), | |
| reportQuantityRS-Indexes | MeasReportQuantity | OPTIONAL, -- Need R |
| maxNrofRS-IndexesToReport | INTEGER (1..maxNrofIndexesToReport) | OPTIONAL, -- |

Need R

| includeBeamMeasurements | BOOLEAN, | |
|---|---|---|
| reportAddNeighMeas | ENUMERATED {setup} | OPTIONAL, -- Need R |

```
  ...,
  [[
```

| | | |
|---|---|---|
| measRSSI-ReportConfig-r16 | MeasRSSI-ReportConfig-r16 | OPTIONAL, -- Need R |
| useT312-r16 | BOOLEAN | OPTIONAL, -- Need M |
| includeCommonLocationInfo-r16 | ENUMERATED {true} | OPTIONAL, -- Need |

R

| | | |
|---|---|---|
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Ne |

ed M

| | | |
|---|---|---|
| includeSensor-Meas-r16 | SetupRelease {Sensor-NameList-r16} | OPTIONAL -- Need |

```
M
  ]],
  [[
```

| | | |
|---|---|---|
| coarseLocationRequest-r17 | ENUMERATED {true} | OPTIONAL, -- Need R |
| reportQuantityRelay-r17 | SL-MeasReportQuantity-r16 | OPTIONAL -- Need R |

```
  ]],
  [[
```

| | | |
|---|---|---|
| numberOfTriggeringCells-r18 | INTEGER (2..maxCellReport) | OPTIONAL -- Need R |

]]
}

In the case of Event A3H1, the UE 1f-01 may consider that an entering condition for the corresponding event is satisfied when both the condition A3H1-1 and the condition A3H1-2 are satisfied.
Condition A3H1-1: Mₙ+Ofn+Ocn-Hys1>Mp+Ofp+Ocp+Off
Condition A3H1-2: Ms-Hys2>Thresh

In the case of Event A3H1, the UE 1f-01 may consider that a leaving condition for the corresponding event is satisfied when at least one of the condition A3H1-3 and the condition A3H1-4 is satisfied.
Condition A3H1-3: Mₙ+Ofn+Ocn+Hys1<Mp+Ofp+Ocp+Off
Condition A3H1-4: Ms-Hys2<Thresh

For reference, the definition for parameters used for the equations of Event A3H1 is described below.

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys1 is the hysteresis parameter for this event (i.e. a3-Hysteresis as defined within reportConfigNR for this event).

Off is the offset parameter for this event (i.e. a3-Offset as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh is the threshold parameter for this event (i.e. h1-Threshold as defined within reportConfigNR for this event).

Mn, Mp are expressed in dBm in case of RSRP, or in dB in case of RSRQ and RS-SINR.

Ofn, Ocn, Hys1, Ofp, Ocp, Off are expressed in dB.

Ms, Hys2, Thresh are expressed in meters.

In the case of Event A3H2, the UE 1f-01 may consider that an entering condition for the corresponding event is satisfied when both the condition A3H2-1 and the condition A3H2-2 are satisfied.
Condition A3H2-1: Mₙ+Ofn+Ocn-Hys1>Mp+Ofp+Ocp+Off
Condition A3H2-2: Ms+Hys2<Thresh

In the case of Event A3H2, the UE 1f-01 may consider that a leaving condition for the corresponding event is satisfied when at least one of the condition A3H2-3 and the condition A3H2-4 is satisfied.
Condition A3H2-3: Mₙ+Ofn+Ocn+Hys1<Mp+Ofp+Ocp+Off
Condition A3H2-4: Ms-Hys2>Thresh

For reference, the definition for parameters used for the equations of Event A3H2 is described below.

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys1 is the hysteresis parameter for this event (i.e. a3-Hysteresis as defined within reportConfigNR for this event).

Off is the offset parameter for this event (i.e. a3-Offset as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh is the threshold parameter for this event (i.e. h2-Threshold as defined within reportConfigNR for this event).

Mn, Mp are expressed in dBm in case of RSRP, or in dB in case of RSRQ and RS-SINR.

Ofn, Ocn, Hys1, Ofp, Ocp, Off are expressed in dB.

Ms, Hys2, Thresh are expressed in meters.

In the case of Event A4H1, the UE 1f-01 may consider that an entering condition for the corresponding event is satisfied when both the condition A4H1-1 and the condition A4H1-2 are satisfied.
Condition A4H1-1: Mₙ+Ofn+Ocn-Hys1>Thresh1
Condition A4H1-2: Ms-Hys2>Thresh2

In the case of Event A4H1, the UE 1f-01 may consider that a leaving condition for the corresponding event is satisfied when at least one of the condition A4H1-3 and the condition A4H1-4 is satisfied.
Condition A4H1-3: Mₙ+Ofn+Ocn+Hys1<Thresh1
Condition A4H1-4: Ms+Hys2<Thresh2

For reference, the definition for parameters used for the equations of Event A4H1 is described below.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a4-Hysteresis as defined within reportConfigNR for this event).

Thresh1 is the threshold parameter for this event (i.e. a4-Threshold as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh2 is the threshold parameter for this event (i.e. h1-Threshold as defined within reportConfigNR for this event).

Mn is expressed in dBm in case of RSRP, or in dB in case of RSRQ and RS-SINR.

Ofn, Ocn, Hys are expressed in dB.

Thresh1 is expressed in the same unit as Mₙ.

Ms, Hys2, Thresh2 are expressed in meters.

In the case of Event A4H2, the UE 1f-01 may consider that an entering condition for the corresponding event is satisfied when both the condition A4H2-1 and the condition A4H2-2 are satisfied.
Condition A4H2-1: Mₙ+Ofn+Ocn-Hys1>Thresh1
Condition A4H2-2: Ms+Hys2<Thresh2

In the case of Event A4H2, the UE 1f-01 may consider that a leaving condition for the corresponding event is satisfied when at least one of the condition A4H2-3 and the condition A4H2-4 is satisfied.
Condition A4H2-3: Mₙ+Ofn+Ocn+Hys1<Thresh1
Condition A4H2-4: Ms-Hys2>Thresh2

For reference, the dentition for parameters used for the equations of Event A4H2 is described below.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a4-Hysteresis as defined within reportConfigNR for this event).

Thresh1 is the threshold parameter for this event (i.e. a4-Threshold as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh2 is the threshold parameter for this event (i.e. h2-Threshold as defined within reportConfigNR for this event).

Mn is expressed in dBm in case of RSRP, or in dB in case of RSRQ and RS-SINR.

Ofn, Ocn, Hys are expressed in dB.

Thresh1 is expressed in the same unit as Mₙ.

Ms, Hys2, Thresh2 are expressed in meters.

In the case of Event A5H1, the UE 1f-01 may consider that an entering condition for the corresponding event is satisfied when all of the condition A5H1-1, the condition A5H1-2, and A5H1-3 are satisfied.
Condition A5H1-1: Mp+Hys1<Thresh1
Condition A5H1-2: Mₙ+Ofn+Ocn-Hys1>Thresh2
Condition A5H1-3: Ms-Hys2>Thresh3

In the case of Event A5H1, the UE 1f-01 may consider that a leaving condition for the corresponding event is satisfied when at least one of the condition A5H1-4, the condition A5H1-5, and the condition A5H1-6 is satisfied.
Condition A5H1-4: Mp-Hys1>Thresh1
Condition A5H1-5: Mₙ+Ofn+Ocn+Hys1<Thresh2
Condition A5H1-6: Ms+Hys2<Thresh3

For reference, the definition for parameters used for the equations of Event A5H1 is described below.

Mp is the measurement result of the NR SpCell, not taking into account any offsets.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a5-Hysteresis as defined within reportConfigNR for this event).

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh3 is the threshold parameter for this event (i.e. h1-Threshold as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mₙ.

Ms, Hys2, Thresh3 are expressed in meters.

In the case of Event A5H2, the UE 1f-01 may consider that an entering condition for the corresponding event is satisfied when all of the condition A5H2-1, the condition A5H2-2, and A5H2-3 are satisfied.
Condition A5H2-1: Mp+Hys1<Thresh1
Condition A5H2-2: Mn+Ofn+Ocn-Hys1>Thresh2
Condition A5H2-3: Ms+Hys2<Thresh3

In the case of Event A5H2, the UE 1f-01 may consider that a leaving condition for the corresponding event is satisfied when at least one of the condition A5H2-4, the condition A5H2-5, and the condition A5H2-6 is satisfied.
Condition A5H2-4: Mp-Hys1>Thresh1
Condition A5H2-5: Mn+Ofn+Ocn+Hys1<Thresh2
Condition A5H2-6: Ms-Hys2>Thresh3

For reference, the definition for parameters used for the equations of Event A5H2 is described below.

Mp is the measurement result of the NR SpCell, not taking into account any offsets.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a5-Hysteresis as defined within reportConfigNR for this event).

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh3 is the threshold parameter for this event (i.e. h2-Threshold as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mn.

Ms, Hys2, Thresh3 are expressed in meters.

For convenience of description, the disclosure is described based on that reportType of ReportConfigNR is configured as eventTriggered, and eventId of EventTriggerConfig in eventTriggered is configured as eventA4H1. Of course, the following description may be equally applied to other event conditions (for example, eventA3H1, eventA3H2, eventA4H2, eventA5H1, and eventA5H2). For reference, the disclosure is described based on that reportConfig configuring the eventA4H1 does not include numberOfTriggeringCells.

In operation 1f-20, the UE 1f-01 may perform measurement, based on the measurement configuration information received in operation 1f-15. This may follow the above-described embodiment.

In operation 1f-25, the UE 1f-01 may determine whether to trigger measurement reporting by determining whether an entry condition for eventA4H1 is satisfied based on the measurement configuration information received in operation 1f-20. Specifically, the UE 1f-01 may determine which cell is applicable as follows.

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the eventA3 or eventA5 or eventA3H1 or eventA3H2 or eventA5H1 or eventA5H2 is configured in the corresponding reportConfig:
         5> if a serving cell is associated with a measObjectNR and neighbours are associated with another measObjectNR, consider any serving cell associated with the other measObjectNR to be a neighbouring cell as well;
         4> for measurement events other than eventA1, eventA2, eventD1, eventX2, eventH1 or eventH2:
         5> if useAllowedCellList is set to true:
         6> consider any neighbouring cell detected based on parameters in the associated measObjectNR to be applicable when the concerned cell is included in the allowedCellsToAddModList defined within the VarMeasConfig for this measId;
         5> else:
         6> consider any neighbouring cell detected based on parameters in the associated measObjectNR to be applicable when the concerned cell is not included in the excludedCellsToAddModList defined within the VarMeasConfig for this measId;
The UE 1f-01 may determine whether the following entry condition applicable to the eventA4H1 is satisfied during timeToTrigger defined by the eventA4H1 within VarMeasConfig corresponding to a UE parameter in the state where a measurement reporting entry for a measurement identity (that is, measId) linked to the eventA4H1 is not included in VarMeasReportList (when a first cell triggers the event).
   Entry condition:
   The case where there is a cell(s) having the measurement results (for example, cell measurement result value) of layer 3 filtering that satisfy condition A4H1-1 among one or a plurality of cells applicable to Event A4H1 and a flight altitude of the UE 1f-01 satisfies condition A4H1-2

That is, when the entry condition is satisfied during timeToTrigger, the UE 1f-01 may perform the following procedure.
3> include a measurement reporting entry within the VarMeasReportList for this measId;
3> set the numberOfReportsSent defined within the VarMeasReportList for this measId to 0;
3> include the concerned cell(s) in the cellsTriggeredList defined within the VarMeasReportList for this measId;
3> if use T312 is set to true in reportConfig for this event:
4> if T310 for the corresponding SpCell is running; and
4> if T312 is not running for corresponding SpCell:
   5> start timer T312 for the corresponding SpCell with the value of T312 configured in the corresponding measObjectNR;
3> initiate the measurement reporting procedure, as specified in 1f-30;

When the measurement reporting procedure is initiated in operation 1f-25, the UE 1f-01 may transmit a measurement result message (MeasurementReport) to the gNB 1f-02 according to the following procedure in operation 1f-30.

For the measId for which the measurement reporting procedure was triggered, the UE shall set the measResults within the MeasurementReport message as follows:
1> set the measId to the measurement identity that triggered the measurement reporting;
1> for each serving cell configured with serving CellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report; 4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include

beam measurement information according to the associated reportConfig as described in 5.5.5.2, where availability is considered according to the measurement configuration associated with the SCG;
1> if the measRSSI-ReportConfig is configured within the corresponding reportConfig for this measId:
   2> set the rssi-Result to the linear average of sample value(s) provided by lower layers in the reportInterval;
   2> set the channelOccupancy to the rounded percentage of sample values which are beyond the channelOccupancyThreshold within all the sample values in the reportInterval;
1> if the UE is acting as L2 U2N Remote UE:
   2> set the sl-MeasResultServingRelay in accordance with the following:
      3> set the cellIdentity to include the cellAccessRelatedInfo contained in the discovery message received from the serving L2 U2N Relay UE;
      3> set the sl-RelayUE-Identity to include the Source L2 ID of the serving L2 U2N Relay;
      3> set the sl-MeasResult to include the SL-RSRP of the serving L2 U2N Relay UE;

NOTE 1: In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
1> if there is at least one applicable neighbouring cell or candidate L2 U2N Relay UE to report:
   2> if the reportType is set to eventTriggered or periodical:
      3> if the measurement report concerns the candidate L2 U2N Relay UE:
         4> set the sl-MeasResultsCandRelay in measResultNeighCells to include the best candidate L2 U2N Relay UEs up to maxNrofRelayMeas in accordance with the following:
         5> if the reportType is set to eventTriggered:
         6> include the L2 U2N Relay UEs included in the relaysTriggeredList as defined within the VarMeasReportList for this measId;
         5> else:
         6> include the applicable L2 U2N Relay UEs for which the new measurement results became available since the last periodical reporting or since the measurement was initiated or reset;
         5> for each L2 U2N Relay UE that is included in the sl-MeasResultsCandRelay:
         6> set the cellIdentity to include the cellAccessRelatedInfo contained in the discovery message received from the concerned L2 U2N Relay UE;
         6> set the sl-RelayUE-Identity to include the Source L2 ID of the concerned L2 U2N Relay UE;
         6> set the sl-MeasResult to include the SD-RSRP of the concerned L2 U2N Relay UE;
         5> for each included L2 U2N Relay UE, include the layer 3 filtered measured results in accordance with the reportConfig for this measId, ordered as follows:
         6> set the sl-MeasResult to include the quantity (ies) indicated in the reportQuantityRelay within the concerned reportConfigRelay in decreasing order of the sorting quantity, determined as specified in 5.5.5.3, i.e. the best L2 U2N Relay UE is included first;
      3> else:
         4> set the measResultNeighCells to include the best neighbouring cells up to maxReportCells in accordance with the following:
         5> if the reportType is set to eventTriggered and eventId is not set to eventD1 or eventH1 or eventH2:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         7> if the measObject associated with this measId concerns E-UTRA:
         8> set the measResult to include the quantity (ies) indicated in the reportQuantity within the concerned reportConfigInterRAT in decreasing order of the sorting quantity, determined as specified in 5.5.5.3, i.e. the best cell is included first;
         7> if the measObject associated with this measId concerns UTRA-FDD and if ReportConfigInterRAT includes the reportQuantityUTRA-FDD:
         8> set the measResult to include the quantity (ies) indicated in the reportQuantityUTRA-FDD within the concerned reportConfigInterRAT in decreasing order of the sorting quantity, determined as specified in 5.5.5.3, i.e. the best cell is included first;
   2> else:
      3> if the cell indicated by cellForWhichToReportCGI is an NR cell:
         4> if plmn-IdentityInfoList of the cgi-Info for the concerned cell has been obtained:
         5> include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
         5> include frequencyBandList if available;
         5> for each PLMN-IdentityInfo in plmn-IdentityInfoList:
         6> if the gNB-ID-Length is broadcast:
         7> include gNB-ID-Length;
         4> if nr-CGI-Reporting-NPN is supported by the UE and npn-IdentityInfoList of the cgi-Info for the concerned cell has been obtained:
         5> include the npn-IdentityInfoList including npn-IdentityList, trackingAreaCode, ranac (if available), cellIdentity and cellReservedForOperatorUse for each entry of the npn-IdentityInfoList;
         5> for each NPN-IdentityInfo in NPN-IdentityInfoList:
         6> if the gNB-ID-Length is broadcast:
         7> include gNB-ID-Length;
         5> include cellReservedForOtherUse if available;
         4> else if MIB indicates the SIB1 is not broadcast:
         5> include the noSIB1 including the ssb-SubcarrierOffset and pdcch-ConfigSIB1 obtained from MIB of the concerned cell;
      3> if the cell indicated by cellForWhichToReportCGI is an E-UTRA cell:
         4> if all mandatory fields of the cgi-Info-EPC for the concerned cell have been obtained:
         5> include in the cgi-Info-EPC the fields broadcasted in E-UTRA SystemInformationBlockType1 associated to EPC;
         4> if the UE is E-UTRA/5GC capable and all mandatory fields of the cgi-Info-5GC for the concerned cell have been obtained:
         5> include in the cgi-Info-5GC the fields broadcasted in E-UTRA SystemInformationBlockType1 associated to 5GC;
         4> if the mandatory present fields of the cgi-Info for the cell indicated by the cellForWhichToReportCGI in the associated measObject have been obtained:
         5> include the freqBandIndicator;
         5> if the cell broadcasts the multiBandInfoList, include the multiBandInfoList;
         5> if the cell broadcasts the freqBandIndicatorPriority, include the freqBandIndicatorPriority;
1> if the corresponding measObject concerns NR:
   2> if the reportSFTD-Meas is set to true within the corresponding reportConfigNR for this measId:
      3> set the measResultSFTD-NR in accordance with the following:
         4> set sfn-OffsetResult and frameBoundaryOffsetResult to the measurement results provided by lower layers;
         4> if the reportRSRP is set to true;
         5> set rsrp-Result to the RSRP of the NR PSCell derived based on SSB;
   2> else if the reportSFTD-NeighMeas is included within the corresponding reportConfigNR for this measId:
      3> for each applicable cell which measurement results are available, include an entry in the measResultCellListSFTD-NR and set the contents as follows:
         4> set physCellId to the physical cell identity of the concerned NR neighbour cell.
         4> set sfn-OffsetResult and frameBoundaryOffsetResult to the measurement results provided by lower layers;
         4> if the reportRSRP is set to true:
         5> set rsrp-Result to the RSRP of the concerned cell derived based on SSB;
1> else if the corresponding measObject concerns E-UTRA:
   2> if the reportSFTD-Meas is set to true within the corresponding reportConfigInterRAT for this measId:
      3> set the measResultSFTD-EUTRA in accordance with the following:
         4> set sfn-OffsetResult and frameBoundaryOffsetResult to the measurement results provided by lower layers;
         4> if the reportRSRP is set to true;
         5> set rsrpResult-EUTRA to the RSRP of the EUTRA PSCell;
1> if average uplink PDCP delay values are available:
   2> set the ul-PDCP-DelayValueResultList to include the corresponding average uplink PDCP delay values;
1> if PDCP excess delay measurements are available:
   2> set the ul-PDCP-ExcessDelayResultList to include the corresponding PDCP excess delay measurements;
1> if the includeCommonLocationInfo is configured in the corresponding reportConfig for this measId and detailed location information that has not been reported is available, set the content of commonLocationInfo of the locationInfo as follows:
   2> include the locationTimestamp;
   2> include the locationCoordinate, if available;
   2> include the velocityEstimate, if available;
   2> include the locationError, if available;
   2> include the locationSource, if available;
   2> if available, include the gnss-TOD-msec,
1> if the coarseLocationRequest is set to true in the corresponding reportConfig for this measId:
   2> include coarseLocationInfo, if available;
1> if the includeWLAN-Meas is configured in the corresponding reportConfig for this measId, set the wlan-LocationInfo of the locationInfo in the measResults as follows:
   2> if available, include the LogMeasResultWLAN, in order of decreasing RSSI for WLAN APs;
1> if the includeBT-Meas is configured in the corresponding reportConfig for this measId, set the BT-LocationInfo of the locationInfo in the measResults as follows:
   2> if available, include the LogMeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
   2> if available, include the sensor-MeasurementInformation;
   2> if available, include the sensor-MotionInformation;
1> if the includeAltitudeUE is configured in the corresponding reportConfig for this measId:
   2> set the altitudeUE to include the altitude of the UE;
1> if there is at least one applicable transmission resource pool for NR sidelink communication/discovery (for measResultsSL):
   2> set the measResultsListSL to include the CBR measurement results in accordance with the following:
      3> if the reportType is set to eventTriggered:
         4> include the transmission resource pools included in the poolsTriggeredList as defined within the VarMeasReportList for this measId;
      3> else:
         4> include the applicable transmission resource pools for which the new measurement results became available since the last periodical reporting or since the measurement was initiated or reset;
      3> if the corresponding measObject concerns NR sidelink communication/discovery, then for each transmission resource pool to be reported:
         4> set the sl-poolReportIdentity to the identity of this transmission resource pool;
         4> set the sl-CBR-ResultsNR to the CBR measurement results on PSSCH and PSCCH of this transmission resource pool provided by lower layers, if available;

NOTE 1: Void.
1> if there is at least one applicable CLI measurement resource to report:
   2> if the reportType is set to cli-EventTriggered or cli-Periodical:
      3> set the measResultCLI to include the most interfering SRS resources or most interfering CLI-RSSI resources up to maxReportCLI in accordance with the following:
         4> if the reportType is set to cli-EventTriggered:
         5> if trigger quantity is set to srs-RSRP i.e. i1-Threshold is set to srs-RSRP:
         6> include the SRS resource included in the cli-TriggeredList as defined within the VarMeasReportList for this measId;
         5> if trigger quantity is set to cli-RSSI i.e. i1-Threshold is set to cli-RSSI:
         6> include the CLI-RSSI resource included in the cli-TriggeredList as defined within the VarMeasReportList for this measId;
         4> else:
         5> if reprotQuantityCLI is set to srs-rsp:
         6> include the applicable CLI-RSSI resources for which the new measurement results became available since the last periodical reporting or since the measurement was initiated or reset;
         5> else:
         6> include the applicable CLI-RSSI resources for which the new measurement results became available since the last periodical reporting or since the measurement was initiated or reset;
         4> for each SRS resource that is included in the measResultCLI:
         5> include the srs-ResourceId;
         5> set srs-RSRP-Result to include the layer 3 filtered measured results in decreasing order, i.e. the most interfering SRS resource is included first;
         4> for each CLI-RSSI resource that is included in the measResultCLI:
         5> include the rssi-ResourceId;
         5> set cli-RSSI-Result to include the layer 3 filtered measured results in decreasing order, i.e. the most interfering CLI-RSSI resource is included first;
1> if there is at least one applicable UE Rx-Tx time difference measurement to report:
   2> set measResultRxTxTimeDiff to the latest measurement result;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> if the measurement reporting was configured by a sl-ConfigDedicatedNR received within the RRCConnectionReconfiguration:
   2> submit the MeasurementReport message to lower layers for transmission via SRB1, embedded in E-UTRA RRC message ULInformationTransferIRAT as specified TS 36.331 [10], clause 5.6.28;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasurementReport message via SRB1 embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.

In operation 1f-35, the UE 1f-01 may determine whether to trigger measurement reporting by determining whether the entry condition for the eventA4H1 is satisfied in the future. Specifically, the UE 1f-01 may determine which cell is applicable as follows. This may follow operation 1f-25. The UE 1f-01 may determine whether the following entry condition applicable to the eventA4H1 is satisfied during timeToTrigger defined by the eventA4H1 within VarMeasConfig corresponding to a UE parameter for a measurement identify (that is, measId) linked to the eventA4H1.
Entry condition:

The case where there is a cell(s) having the measurement results (for example, cell measurement result value) of layer 3 filtering that satisfy condition A4H1-1 among one or a plurality of applicable cells that are not included in cellsTriggerdList defined within VarMeasReportList for measId in operation 1f-25 and a flight altitude of the UE 1f-01 satisfies condition A4H1-2

That is, when the entry condition is satisfied during timeToTrigger, the UE 1f-01 may perform the following procedure.
3> set the numberOfReportsSent defined within the VarMeasReportList for this measId to 0;
3> include the concerned cell(s) in the cellsTriggeredList defined within the VarMeasReportList for this measId;
3> if use T312 is set to true in reportConfig for this event:
4> if T310 for the corresponding SpCell is running; and
4> if T312 is not running for corresponding SpCell:
   5> start timer T312 for the corresponding SpCell with the value of T312 configured in the corresponding measObjectNR;
3> initiate the measurement reporting procedure, as specified in 1f-30;

When the measurement reporting procedure is initiated in operation 1f-35, the UE 1f-01 may transmit a measurement result message (MeasurementReport) to the gNB 1f-02 according to the procedure described in operation 1f-30 in operation 1f-40.

In operation 1f-45, the UE 1f-01 may determine whether to trigger measurement reporting by determining whether the leaving condition for the eventA4H1 is satisfied in the future. Specifically, the UE 1f-01 may determine which cell is applicable as follows. This may follow operation 1f-25. The UE 1f-01 may determine whether at least one following leaving condition is satisfied in associated VarMeasReport within VarMeasReportList for measId linked to eventA4H1 during timeToTrigger defined in VarMeasConfig corresponding to a UE parameter.
Leaving condition 1

The case where there are cells having the measurement results (for example, cell measurement result value) of layer 3 filtering that satisfy the condition A4H-3 among one or a plurality of cells included in cellsTriggerdList defined within VarMeasReportList for measId in operation 1f-25 or operation 1f-35
Leaving condition 2
The case where the flight altitude of the UE satisfies the condition A4H1-4

In the disclosure, when at least one leaving condition is satisfied during timeToTrigger, the UE 1f-01 may perform at least one of the following proposed methods (that is, perform a combination of the following methods or only one method).
The case where at least one of leaving condition 1 and leaving condition 2 is satisfied during timeToTrigger,
If leaving condition 1 is satisfied during timeToTrigger,
Cell(s) that satisfies leaving condition 1 may be removed among cells in cellsTriggeredList defined in measId within VarMeasReportList.
If reportOnLeave is set to true in the report condition information, the UE 1f-01 may initiate the measurement reporting procedure and transmit the measurement result message (MeasurementReport) to the gNB 1f-02 in operation 1f-50.
Method 1:
A measurement reporting entry for measID within VarMeasReportList may be removed
If a periodical reporting timer is running for measId, the timer may be stopped.

### Method 2:

If cellsTriggeredL is defined in measId within VarMeasReportList is empty,
   The measurement reporting entry for measId within VarMeasReportList may be removed.
   When a periodical reporting timer is running for measId, the timer may be stopped.

In the case of method 1, when reportOnLeave is set to true, the UE 1f-01 may provide information on cell(s) included in cellsTriggeredList to the gNB 1f-02 through the measurement reporting procedure, and has a characteristic of removing the measurement reporting entry for measId associated with corresponding eventA4H1. Accordingly, the gNB 1f-02 may know which cell satisfies leaving condition 1, and there is an advantage in that the UE 1f-01 does not have to make the frequent measurement report since the measurement reporting procedure is initiated to the gNB 1f-02 only when the entry condition for eventA4H1 associated with measId is satisfied in the future.

In the case of method 2, since the UE 1f-01 removes the measurement reporting entry only when cellsTriggeredList defined in measId associated with eventA4H1 within VarMeasReportList is empty, there is an advantage in that the gNB 1f-02 may continuously receive information indicating which cell(s) satisfy the entry condition or the leaving condition for eventA4H1.

When only leaving condition 1 is satisfied during timeToTrigger, leaving condition 2 is not satisfied during timeToTrigger, and the flight altitude of the UE 1f-01 satisfies condition A4H1-2 during timeToTrigger, the UE 1f-01 may apply method 2.

FIG. 1G is a flowchart illustrating a process in which an uncrewed aerial vehicle (UAV) UE transmits an event AxHy-based measurement result message to a gNB in a next-generation mobile communication system according to an embodiment of the disclosure.

The UAV UE may be a UE that is able to fly. Accordingly, the UAV UE has a characteristic of having a higher probability of line of sight than a terrestrial UE. Therefore, the UAV UE may have a disadvantage of receiving downlink (hereinafter, referred to as DL) interference from more cells compared to the terrestrial UE. That is, the UAV UE has a characteristic of receiving DL interference at a high level from more neighboring cells compared to the terrestrial UE. Similarly, the UAV UE has a characteristic of giving uplink (hereinafter, referred to as UL) interference to more cells compared to the terrestrial UE. Accordingly, a method by which the UAV UE reports MeasurementReport to the gNB when a predetermined event is met in a predetermined altitude range area is proposed.

Referring to FIG. 1G, in operation 1g-05, a UAV UE 1g-01 may establish an RRC connection with an NR gNB 1g-02 to be in an RRC-connected mode (RRC_CONNECTED).

In operation 1g-10, the UAV UE 1g-01 may transmit a UE capability information message (UECapabilityInformation) to the gNB 1g-02. This may follow at least one of the above-described embodiments. In addition, the message may include capability information indicating whether the UE 1g-01 supports numberOfTriggeringCells. numberOfTriggeringCells means the number of cells required for satisfying an event that triggers the measurement report, and may be applied only to events considering neighboring cells. For example, the corresponding events may be at least one event among eventA3, eventA4, eventA5, eventA3H1, eventA3H2, eventA4H1, eventA4H2, eventA5H1, and eventA5H2. For reference, description of the above-listed events is made below.
Event A3: Neighbour becomes amount of offset better than PCell/PSCell.
Event A4: Neighbour becomes better than absolute threshold.
Event A5: PCell/PSCell s worse than absolute threshold1 AND Neighbour/SCell becomes better than another absolute threshold2.
Event A3H1: Neighbour becomes offset better than SpCell and the Aerial UE altitude becomes higher than a threshold.
Event A3H2: Neighbour becomes offset better than SpCell and the Aerial UE altitude becomes lower than a threshold.
Event A4H1: Neighbour becomes better than threshold1 and the Aerial UE altitude becomes higher than a threshold2.
Event A4H2: Neighbour becomes better than threshold1 and the Aerial UE altitude becomes lower than a threshold2.
Event A5H1: SpCell becomes worse than threshold1 and neighbour becomes better than threshold2 and the Aerial UE altitude becomes higher than a threshold3.

Event A5H2: SpCell becomes worse than threshold1 and neighbour becomes better than threshold2 and the Aerial UE altitude becomes lower than a threshold3.

In operation 1ge-15, the gNB 1g-02 may transmit a predetermined RRC message (for example, RRCReconfiguration) containing measurement configuration information (MeasConfig) to the UE 1g-01. The gNB 1g-02 following the disclosure may configure eventAxHy in the UE 1g-01 through the report configuration information (ReportConfigNR). In addition, the gNB 1g-02 following the disclosure may also configure numberOfTriggeringCells when configuring eventAxHy in the UE 1g-01. For example, the gNB 1g-02 may configure, in the UE 1g-01, a report type (reportType) for each ReportConfigNR as one of eventA3H1, eventA3H2, eventA4H1, eventA4H2, eventA5H1, and eventA5H2, and a format of ASN.1 therefor is as shown in Table 7 below.

TABLE 7

| | |
|---|---|
| ReportConfigNR ::= | SEQUENCE { |
| reportType | CHOICE { |
| periodical | PeriodicalReportConfig, |
| eventTriggered | EventTriggerConfig, |

```
    ...,
    [omitted]
```

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distance ThreshFromReference1-r17 | INTEGER(1..65525), |
| distance ThreshFromReference2-r17 | INTEGER(1..65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]],
    [[
```

| | |
|---|---|
| eventH1-r18 | SEQUENCE { |
| h1-Threshold-r18 | Altitude-r18, |
| h1-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN |

},

| | |
|---|---|
| eventH2-r18 | SEQUENCE { |
| h2-Threshold-r18 | Altitude-r18, |
| h2-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN |

},

| | |
|---|---|
| eventA3H1-r18 | SEQUENCE { |
| a3-Offset-r18 | MeasTriggerQuantityOffset, |
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA3H2-r18 | SEQUENCE { |
| a3-Offset-r18 | MeasTriggerQuantityOffset, |
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

},

| | |
|---|---|
| eventA4H1-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA4H2-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

},

| | |
|---|---|
| eventA5H1-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA5H2-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

```
    }
    ]]
  },
```

| rsType | NR-RS-Type, | |
|---|---|---|
| reportInterval | ReportInterval, | |
| reportAmount | ENUMERATED {r1, r2, r4, r8, r16, r32, r64, infinity}, | |
| reportQuantityCell | MeasReportQuantity, | |
| maxReportCells | INTEGER (1..maxCellReport), | |
| reportQuantityRS-Indexes | MeasReportQuantity | OPTIONAL, -- Need R |
| maxNrofRS-IndexesToReport | INTEGER (1..maxNrofIndexesToReport) | OPTIONAL, -- |

Need R

| includeBeamMeasurements | BOOLEAN, | |
|---|---|---|
| reportAddNeighMeas | ENUMERATED {setup} | OPTIONAL, -- Need R |

```
  ...,
  [[
```

| | | |
|---|---|---|
| measRSSI-ReportConfig-r16 | MeasRSSI-ReportConfig-r16 | OPTIONAL, -- Need R |
| useT312-r16 | BOOLEAN | OPTIONAL, -- Need M |
| includeCommonLocationInfo-r16 | ENUMERATED {true} | OPTIONAL, -- Need |

R

| | | |
|---|---|---|
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Ne |

ed M

| | | |
|---|---|---|
| includeSensor-Meas-r16 | SetupRelease {Sensor-NameList-r16} | OPTIONAL -- Need |

```
M
  ]],
  [[
```

| | | |
|---|---|---|
| coarseLocationRequest-r17 | ENUMERATED {true} | OPTIONAL, -- Need R |
| reportQuantityRelay-r17 | SL-MeasReportQuantity-r16 | OPTIONAL -- Need R |

```
  ]],
  [[
```

| | | |
|---|---|---|
| numberOfTriggeringCells-r18 | INTEGER (2..maxCellReport) | OPTIONAL -- Need R |

]]
}

In the case of Event A3H1, the UE 1g-01 may consider that an entering condition for the corresponding event is satisfied when both the condition A3H1-1 and the condition A3H1-2 are satisfied.
Condition A3H1-1: Mn+Ofn+Ocn-Hys1>Mp+Ofp+Ocp+Off
Condition A3H1-2: Ms-Hys2>Thresh

In the case of Event A3H1, the UE 1g-01 may consider that a leaving condition for the corresponding event is satisfied when at least one of the condition A3H1-3 and the condition A3H1-4 is satisfied.
Condition A3H1-3: Mn+Ofn+Ocn+Hys1<Mp+Ofp+Ocp+Off
Condition A3H1-4: Ms+Hys2<Thresh

For reference, the definition for parameters used for the equations of Event A3H1 is described below.

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys1 is the hysteresis parameter for this event (i.e. a3-Hysteresis as defined within reportConfigNR for this event).

Off is the offset parameter for this event (i.e. a3-Offset as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh is the threshold parameter for this event (i.e. h1-Threshold as defined within reportConfigNR for this event).

Mn, Mp are expressed in dBm in case of RSRP, or in dB in case of RSRQ and RS-SINR.

Ofn, Ocn, Hys1, Ofp, Ocp, Off are expressed in dB.

Ms, Hys2, Thresh are expressed in meters.

In the case of Event A3H2, the UE 1g-01 may consider that an entering condition for the corresponding event is satisfied when both the condition A3H2-1 and the condition A3H2-2 are satisfied.
Condition A3H2-1: Mn+Ofn+Ocn-Hys1>Mp+Ofp+Ocp+Off
Condition A3H2-2: Ms+Hys2<Thresh

In the case of Event A3H2, the UE 1g-01 may consider that a leaving condition for the corresponding event is satisfied when at least one of the condition A3H2-3 and the condition A3H2-4 is satisfied.
Condition A3H2-3: Mn+Ofn+Ocn+Hys1<Mp+Ofp+Ocp+Off
Condition A3H2-4: Ms-Hys>Thresh

For reference, the definition for parameters used for the equations of Event A3H2 is described below.

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys1 is the hysteresis parameter for this event (i.e. a3-Hysteresis as defined within reportConfigNR for this event).

Off is the offset parameter for this event (i.e. a3-Offset as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh is the threshold parameter for this event (i.e. h2-Threshold as defined within reportConfigNR for this event).

Mn, Mp are expressed in dBm in case of RSRP, or in dB in case of RSRQ and RS-SINR.

Ofn, Ocn, Hys1, Ofp, Ocp, Off are expressed in dB.

Ms, Hys2, Thresh are expressed in meters.

In the case of Event A4H1, the UE 1g-01 may consider that an entering condition for the corresponding event is satisfied when both the condition A4H1-1 and the condition A4H1-2 are satisfied.
Condition A4H1-1: Mn+Ofn+Ocn-Hys1>Thresh1
Condition A4H1-2: Ms-Hys2>Thresh2

In the case of Event A4H1, the UE 1g-01 may consider that a leaving condition for the corresponding event is satisfied when at least one of the condition A4H1-3 and the condition A4H1-4 is satisfied.
Condition A4H1-3: Mn+Ofn+Ocn+Hys1<Thresh1
Condition A4H1-4: Ms+Hys2<Thresh2

For reference, the definition for parameters used for the equations of

Event A4H1 is described below.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a4-Hysteresis as defined within reportConfigNR for this event).

Thresh1 is the threshold parameter for this event (i.e. a4-Threshold as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh2 is the threshold parameter for this event (i.e. h1-Threshold as defined within reportConfigNR for this event).

Mn is expressed in dBm in case of RSRP, or in dB in case of RSRQ and RS-SINR.

Ofn, Ocn, Hys are expressed in dB.

Thresh1 is expressed in the same unit as Mn.

Ms, Hys2, Thresh2 are expressed in meters.

In the case of Event A4H2, the UE 1g-01 may consider that an entering condition for the corresponding event is satisfied when both the condition A4H2-1 and the condition A4H2-2 are satisfied.
Condition A4H2-1: Mn+Ofn+Ocn-Hys1>Thresh1
Condition A4H2-2: Ms+Hys2<Thresh2

In the case of Event A4H2, the UE 1g-01 may consider that a leaving condition for the corresponding event is satisfied when at least one of the condition A4H2-3 and the condition A4H2-4 is satisfied.
Condition A4H2-3: Mn+Ofn+Ocn+Hys1<Thresh1
Condition A4H2-4: Ms-Hys2>Thresh2

For reference, the definition for parameters used for the equations of Event A4H2 is described below.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys is the hysteresis parameter for this event (i.e. a4-Hysteresis as defined within reportConfigNR for this event).

Thresh1 is the threshold parameter for this event (i.e. a4-Threshold as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh2 is the threshold parameter for this event (i.e. h2-Threshold as defined within reportConfigNR for this event).

Mn is expressed in dBm in case of RSRP, or in dB in case of RSRQ and RS-SINR.

Ofn, Ocn, Hys are expressed in dB.

Thresh1 is expressed in the same unit as Mn.

Ms, Hys2, Thresh2 are expressed in meters.

In the case of Event A5H1, the UE 1g-01 may consider that an entering condition for the corresponding event is satisfied when all of the condition A5H1-1, the condition A5H1-2, and A5H1-3 are satisfied.
Condition A5H1-1: Mp+Hys1<Thresh1
Condition A5H1-2: Mn+Ofn+Ocn-Hys1>Thresh2
Condition A5H1-3: Ms-Hys2>Thresh3

In the case of Event A5H1, the UE 1g-01 may consider that a leaving condition for the corresponding event is satisfied when at least one of the condition A5H1-4, the condition A5H1-5, and the condition A5H1-6 is satisfied.
Condition A5H1-4: Mp-Hys1>Thresh1
Condition A5H1-5: Mn+Ofn+Ocn+Hys1<Thresh2
Condition A5H1-6: Ms+Hys2<Thresh3

For reference, the definition for parameters used for the equations of Event A5H1 is described below.

Mp is the measurement result of the NR SpCell, not taking into account any offsets.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a5-Hysteresis as defined within reportConfigNR for this event).

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh3 is the threshold parameter for this event (i.e. h1-Threshold as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mn.

Ms, Hys2, Thresh3 are expressed in meters.

In the case of Event A5H2, the UE 1g-01 may consider that an entering condition for the corresponding event is satisfied when all of the condition A5H2-1, the condition A5H2-2, and A5H2-3 are satisfied.
Condition A5H2-1: Mp+Hys1<Thresh1
Condition A5H2-2: Mn+Ofn+Ocn-Hys1>Thresh2
Condition A5H2-3: Ms+Hys2<Thresh3

In the case of Event A5H2, the UE 1g-01 may consider that a leaving condition for the corresponding event is satisfied when at least one of the condition A5H2-4, the condition A5H2-5, and the condition A5H2-6 is satisfied.
Condition A5H2-4: Mp-Hys1>Thresh1
Condition A5H2-5: Mn+Ofn+Ocn+Hys1<Thresh2
Condition A5H2-6: Ms-Hys2>Thresh3

For reference, the definition for parameters used for the equations of Event A5H2 is described below.

Mp is the measurement result of the NR SpCell, not taking into account any offsets.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a5-Hysteresis as defined within reportConfigNR for this event).

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh3 is the threshold parameter for this event (i.e. h2-Threshold as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mn.

Ms, Hys2, Thresh3 are expressed in meters.

For convenience of description, the disclosure is described based on that reportType of ReportConfigNR is configured as eventTriggered, and eventId of EventTriggerConfig in eventTriggered is configured as eventA4H1. Of course, the following description may be equally applied to other event conditions (for example, eventA3H1, eventA3H2, eventA4H2, eventA5H1, and eventA5H2). For reference, the disclosure is described based on that reportConfig configuring the eventA4H1 includes numberOfTriggeringCells.

In operation 1g-20, the UE 1g-01 may perform measurement, based on the measurement configuration information received in operation 1g-15. This may follow the above-described embodiment.

In operation 1g-25, the UE 1g-01 may determine whether the entry condition for eventA4H1 is satisfied based on the measurement configuration information received in operation 1g-20. Specifically, the UE 1g-01 may determine which cell is applicable as follows.

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the eventA3 or eventA5 or eventA3H1 or eventA3H2 or eventA5H1 or eventA5H2 is configured in the corresponding reportConfig:
         5> if a serving cell is associated with a measObjectNR and neighbours are associated with another measObjectNR, consider any serving cell associated with the other measObjectNR to be a neighbouring cell as well;
         4> for measurement events other than eventA1, eventA2, eventD1, eventX2, eventH1 or eventH2:
         5> if useAllowedCellList is set to true:
         6> consider any neighbouring cell detected based on parameters in the associated measObjectNR to be applicable when the concerned cell is included in the allowedCellsToAddModList defined within the VarMeasConfig for this measId;
         5> else:
         6> consider any neighbouring cell detected based on parameters in the associated measObjectNR to be applicable when the concerned cell is not included in the excludedCellsToAddModList defined within the VarMeasConfig for this measId;
The UE 1g-01 may determine whether the following entry condition applicable to the eventA4H1 is satisfied during timeToTrigger defined by the eventA4H1 within VarMeasConfig corresponding to a UE parameter.
   Entry condition:
   The case where there is a cell(s) having the measurement results (for example, cell measurement result value) of layer 3 filtering that satisfy the condition A4H1-1 among one or a plurality of cells applicable to EventA4H1 and the flight altitude of the UE 1g-01 satisfies the condition A4H1-2

In the embodiment, it is assumed that the number of cell(s) that satisfy the entry condition for the event during timeToTrigger is smaller than numberOfTriggeringCells, and thus the UE 1g-01 may perform the following procedure without initiating the measurement reporting procedure.
If the measurement reporting entry is not included in VarMeasReportList for measId linked to the eventA4H1 (when a first cell triggers the event),
The measurement reporting entry for measId may be included in VarMeasReportList.
Cells that satisfy the entry condition may be included in cellsTriggeredList defined in VarMeasReportList by measId. For reference, the UE 1g-01 may include, in cellsTriggeredList, only cells that are not included in cellsTriggeredList.

In operation 1g-30, the UE 1g-01 may determine whether to trigger measurement reporting by determining whether the leaving condition for the eventA4H1 is satisfied. Specifically, the UE 1g-01 may determine which cell is applicable as follows. This may follow operation 1g-25. The UE 1g-01 may determine whether at least one following leaving condition is satisfied in associated VarMeasReport within VarMeasReportList for measId linked to eventA4H1 during timeToTrigger defined in VarMeasConfig corresponding to a UE parameter.
Leaving condition 1
The case where there are cells having the measurement results (for example, cell measurement result value) of layer 3 filtering that satisfy the condition A4H-3 among one or a plurality of cells included in cellsTriggerdList defined within VarMeasReportList for measId in operation 1g-25
Leaving condition 2
The case where the flight altitude of the UE 1g-01 satisfies the condition A4H1-4

In the disclosure, when at least one leaving condition is satisfied during timeToTrigger, the UE 1g-01 may perform at least one of the following proposed methods (that is, perform a combination of the following methods or only one method).
Method 1:
If leaving condition 1 is satisfied during timeToTrigger,
Cell(s) that satisfies leaving condition 1 may be removed among cells in cellsTriggeredList defined in measId within VarMeasReportList.
If the entry condition is satisfied for measId and the measurement report message is not transmitted to the gNB 1g-02 or the removed cell(s) are not transmitted to the gNB 1g-02 through the previous measurement report message, the UE 1g-01 may not initiate the measurement reporting procedure even though reportOnLeave is set to true in the report configuration information linked to measId.
If cellsTriggeredL is defined in measId within VarMeasReportList is empty,
The measurement reporting entry for measId within VarMeasReportList may be removed.
When a periodical reporting timer is running for measId, the timer may be stopped.
Alternatively, the measurement reporting entry for measId within VarMeasReportList may be removed regardless of whether the cell is included in cellsTriggeredList. If a periodical reporting timer is running for measId, this may be stopped.
Method 2:
If leaving condition 1 is satisfied during timeToTrigger,
Cell(s) that satisfies leaving condition 1 may be removed among cells in cellsTriggeredList defined in measId within VarMeasReportList.
If reportOnLeave is set to true in the report configuration information linked to measId,
When only leaving condition 2 is satisfied during timeToTrigger, the UE 1g-01 may initiate the measurement reporting procedure and transmit the measurement report message (MeasurementReport) to the gNB 1g-02 in operation 1g-40. Alternatively, when both leaving condition 1 and leaving condition 2 are satisfied during timeToTrigger, the UE 1g-01 may initiate the measurement reporting procedure and transmit the measurement report message (MeasurementReport) to the gNB 1g-02 in operation 1g-40. For reference, the message may include information indicating which condition(s) between leaving condition 1 and leaving condition 2 is satisfied. Alternatively, when only leaving condition 2 is satisfied, the UE 1g-01 may not include information included in cellsTriggeredList in the measurement report message.
If cellsTriggeredL is defined in measId within VarMeasReportList is empty,
The measurement reporting entry for measId within VarMeasReportList may be removed.
When a periodical reporting timer is running for measId, the timer may be stopped.
Alternatively, the measurement reporting entry for measId within VarMeasReportList may be removed regardless of whether the cell is included in cellsTriggeredList. If a periodical reporting timer is running for measId, this may be stopped.

The method 1 has a characteristic of not transmitting measurement report message to the gNB 1g-02 even though the leaving condition is satisfied for the eventA4H1 when the entry condition is satisfied for the eventA4H1 and thus the UE 1g-01 does not transmit the measurement report message to the gNB 1g-02. Accordingly, the UE 1g-01 has an advantage of not frequently transmitting the measurement report message to the gNB 1g-02 unnecessarily. The gNB 1g-02 also has an advantage of avoiding wrong prediction about which cells satisfy the entry condition or the leaving condition for the eventA4H1.

Method 2 has a characteristic in which the UE 1g-01 transmits the measurement report message to the gNB 1g-02 when leaving condition 2 is satisfied for the eventA4H1 (that is, when the leaving condition for the altitude of the UE 1g-01 is satisfied). Accordingly, the gNB 1g-02 may acquire information indicating the altitude at which the UE 1g-01 is flying and thus efficiently control UE mobility management in the future.

If the measurement reporting procedure is initiated in operation 1g-30, the UE 1g-01 may transmit the measurement result message (MeasurementReport) to the gNB 1g-02 according to the following procedure in operation 1g-35.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig: entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if the measRSSI-ReportConfig is configured within the corresponding reportConfig for this measId:
   2> set the rssi-Result to the linear average of sample value(s) provided by lower layers in the reportInterval;
   2> set the channelOccupancy to the rounded percentage of sample values which are beyond the channelOccupancyThreshold within all the sample values in the reportInterval;
1> if the UE is acting as L2 U2N Remote UE:
   2> set the sl-MeasResultServingRelay in accordance with the following:
      3> set the cellIdentity to include the cellAccessRelatedInfo contained in the discovery message received from the serving L2 U2N Relay UE;
      3> set the sl-RelayUE-Identity to include the Source L2 ID of the serving L2 U2N Relay;
      3> set the sl-MeasResult to include the SL-RSRP of the serving L2 U2N Relay UE;

NOTE 1: In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
1> if there is at least one applicable neighbouring cell or candidate L2 U2N Relay UE to report:
   2> if the reportType is set to eventTriggered or periodical:
      3> if the measurement report concerns the candidate L2 U2N Relay UE:
         4> set the sl-MeasResultsCandRelay in measResultNeighCells to include the best candidate L2 U2N Relay UEs up to maxNrofRelayMeas in accordance with the following:
         5> if the reportType is set to eventTriggered:
         6> include the L2 U2N Relay UEs included in the relaysTriggeredList as defined within the VarMeasReportList for this measId;
         5> else:
         6> include the applicable L2 U2N Relay UEs for which the new measurement results became available since the last periodical reporting or since the measurement was initiated or reset;
         5> for each L2 U2N Relay UE that is included in the sl-MeasResultsCandRelay:
         6> set the cellIdentity to include the cellAccessRelatedInfo contained in the discovery message received from the concerned L2 U2N Relay UE;
         6> set the sl-RelayUE-Identity to include the Source L2 ID of the concerned L2 U2N Relay UE;
         6> set the sl-MeasResult to include the SD-RSRP of the concerned L2 U2N Relay UE;
         5> for each included L2 U2N Relay UE, include the layer 3 filtered measured results in accordance with the reportConfig for this measId, ordered as follows:
         6> set the sl-MeasResult to include the quantity (ies) indicated in the reportQuantityRelay within the concerned reportConfigRelay in decreasing order of the sorting quantity, determined as specified in 5.5.5.3, i.e. the best L2 U2N Relay UE is included first;
      3> else:
         4> set the measResultNeighCells to include the best neighbouring cells up to maxReportCells in accordance with the following:
         5> if the reportType is set to eventTriggered and eventId is not set to eventD1 or eventH1 or eventH2:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         7> if the measObject associated with this measId concerns E-UTRA:
         8> set the measResult to include the quantity (ies) indicated in the reportQuantity within the concerned reportConfigInterRAT in decreasing order of the sorting quantity, determined as specified in 5.5.5.3, i.e. the best cell is included first;
         7> if the measObject associated with this measId concerns UTRA-FDD and if ReportConfigInterRAT includes the reportQuantityUTRA-FDD:
         8> set the measResult to include the quantity (ies) indicated in the reportQuantityUTRA-FDD within the concerned reportConfigInterRAT in decreasing order of the sorting quantity, determined as specified in 5.5.5.3, i.e. the best cell is included first;
   2> else:
      3> if the cell indicated by cellForWhichToReportCGI is an NR cell:
         4> if plmn-IdentityInfoList of the cgi-Info for the concerned cell has been obtained:
         5> include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
         5> include frequencyBandList if available;
         5> for each PLMN-IdentityInfo in plmn-IdentityInfoList:
         6> if the gNB-ID-Length is broadcast:
         7> include gNB-ID-Length;
         4> if nr-CGI-Reporting-NPN is supported by the UE and npn-IdentityInfoList of the cgi-Info for the concerned cell has been obtained:
         5> include the npn-IdentityInfoList including npn-IdentityList, trackingAreaCode, ranac (if available), cellIdentity and cellReservedForOperatorUse for each entry of the npn-IdentityInfoList;
         5> for each NPN-IdentityInfo in NPN-IdentityInfoList:
         6> if the gNB-ID-Length is broadcast:
         7> include gNB-ID-Length;
         5> include cellReservedForOtherUse if available;
         4> else if MIB indicates the SIB1 is not broadcast:
         5> include the noSIB1 including the ssb-SubcarrierOffset and pdcch-ConfigSIB1 obtained from MIB of the concerned cell;
      3> if the cell indicated by cellForWhichToReportCGI is an E-UTRA cell:
         4> if all mandatory fields of the cgi-Info-EPC for the concerned cell have been obtained:
         5> include in the cgi-Info-EPC the fields broadcasted in E-UTRA SystemInformationBlockType1 associated to EPC;
         4> if the UE is E-UTRA/5GC capable and all mandatory fields of the cgi-Info-5GC for the concerned cell have been obtained:
         5> include in the cgi-Info-5GC the fields broadcasted in E-UTRA SystemInformationBlockType1 associated to 5GC;
         4> if the mandatory present fields of the cgi-Info for the cell indicated by the cellForWhichToReportCGI in the associated measObject have been obtained:
         5> include the freqBandIndicator;
         5> if the cell broadcasts the multiBandInfoList, include the multiBandInfoList;
         5> if the cell broadcasts the freqBandIndicatorPriority, include the freqBandIndicatorPriority;
1> if the corresponding measObject concerns NR:
   2> if the reportSFTD-Meas is set to true within the corresponding reportConfigNR for this measId:
      3> set the measResultSFTD-NR in accordance with the following:
         4> set sfn-OffsetResult and frame BoundaryOffsetResult to the measurement results provided by lower layers;
         4> if the reportRSRP is set to true;
         5> set rsrp-Result to the RSRP of the NR PSCell derived based on SSB;
   2> else if the reportSFTD-NeighMeas is included within the corresponding reportConfigNR for this measId:
      3> for each applicable cell which measurement results are available, include an entry in the measResultCellListSFTD-NR and set the contents as follows:
         4> set physCellId to the physical cell identity of the concerned NR neighbour cell.
         4> set sfn-OffsetResult and frameBoundaryOffsetResult to the measurement results provided by lower layers;
         4> if the reportRSRP is set to true:
         5> set rsrp-Result to the RSRP of the concerned cell derived based on SSB;
1> else if the corresponding measObject concerns E-UTRA:
   2> if the reportSFTD-Meas is set to true within the corresponding reportConfigInterRAT for this measId:
      3> set the measResultSFTD-EUTRA in accordance with the following:
         4> set sfn-OffsetResult and frame BoundaryOffsetResult to the measurement results provided by lower layers;
         4> if the reportRSRP is set to true;
         5> set rsrpResult-EUTRA to the RSRP of the EUTRA PSCell;
1> if average uplink PDCP delay values are available:
   2> set the ul-PDCP-DelayValueResultList to include the corresponding average uplink PDCP delay values;
1> if PDCP excess delay measurements are available:
   2> set the ul-PDCP-ExcessDelayResultList to include the corresponding PDCP excess delay measurements;
1> if the includeCommonLocationInfo is configured in the corresponding reportConfig for this measId and detailed location information that has not been reported is available, set the content of commonLocationInfo of the locationInfo as follows:
   2> include the locationTimestamp;
   2> include the locationCoordinate, if available;
   2> include the velocityEstimate, if available;
   2> include the locationError, if available;
   2> include the locationSource, if available;
   2> if available, include the gnss-TOD-msec,
1> if the coarseLocationRequest is set to true in the corresponding reportConfig for this measId:
   2> include coarseLocationInfo, if available;
1> if the includeWLAN-Meas is configured in the corresponding reportConfig for this measId, set the wlan-LocationInfo of the locationInfo in the measResults as follows:
   2> if available, include the LogMeasResultWLAN, in order of decreasing RSSI for WLAN APs;
1> if the includeBT-Meas is configured in the corresponding reportConfig for this measId, set the BT-LocationInfo of the locationInfo in the measResults as follows:
   2> if available, include the LogMeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
   2> if available, include the sensor-MeasurementInformation;
   2> if available, include the sensor-MotionInformation;
1> if the includeAltitudeUE is configured in the corresponding reportConfig for this measId:
   2> set the altitude UE to include the altitude of the UE;
1> if there is at least one applicable transmission resource pool for NR sidelink communication/discovery (for measResultsSL):
   2> set the measResultsListSL to include the CBR measurement results in accordance with the following:
      3> if the reportType is set to eventTriggered:
         4> include the transmission resource pools included in the poolsTriggeredList as defined within the VarMeasReportList for this measId;
      3> else:
         4> include the applicable transmission resource pools for which the new measurement results became available since the last periodical reporting or since the measurement was initiated or reset;
      3> if the corresponding measObject concerns NR sidelink communication/discovery, then for each transmission resource pool to be reported:
         4> set the sl-poolReportIdentity to the identity of this transmission resource pool;
         4> set the sl-CBR-ResultsNR to the CBR measurement results on PSSCH and PSCCH of this transmission resource pool provided by lower layers, if available;

NOTE 1: Void.
1> if there is at least one applicable CLI measurement resource to report:
   2> if the reportType is set to cli-EventTriggered or cli-Periodical:
      3> set the measResultCLI to include the most interfering SRS resources or most interfering CLI-RSSI resources up to maxReportCLI in accordance with the following:
         4> if the reportType is set to cli-EventTriggered:
         5> if trigger quantity is set to srs-RSRP i.e. i1-Threshold is set to srs-RSRP:
         6> include the SRS resource included in the cli-TriggeredList as defined within the VarMeasReportList for this measId;
         5> if trigger quantity is set to cli-RSSI i.e. i1-Threshold is set to cli-RSSI:
         6> include the CLI-RSSI resource included in the cli-TriggeredList as defined within the VarMeasReportList for this measId;
         4> else:
         5> if reportQuantityCLI is set to srs-rsrp:
         6> include the applicable SRS resources for which the new measurement results became available since the last periodical reporting or since the measurement was initiated or reset;
         5> else:
         6> include the applicable CLI-RSSI resources for which the new measurement results became available since the last periodical reporting or since the measurement was initiated or reset;
         4> for each SRS resource that is included in the measResultCLI:
         5> include the srs-ResourceId;
         5> set srs-RSRP-Result to include the layer 3 filtered measured results in decreasing order, i.e. the most interfering SRS resource is included first;
         4> for each CLI-RSSI resource that is included in the measResultCLI:
         5> include the rssi-ResourceId;
         5> set cli-RSSI-Result to include the layer 3 filtered measured results in decreasing order, i.e. the most interfering CLI-RSSI resource is included first;
1> if there is at least one applicable UE Rx-Tx time difference measurement to report:
   2> set measResultRxTxTimeDiff to the latest measurement result;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> if the measurement reporting was configured by a sl-ConfigDedicatedNR received within the RRCConnectionReconfiguration:
   2> submit the MeasurementReport message to lower layers for transmission via SRB1, embedded in E-UTRA RRC message ULInformationTransferIRAT as specified TS 36.331 [10], clause 5.6.28;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasurementReport message via SRB1 embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.

FIG. 1H is a flowchart illustrating a process in which an uncrewed aerial vehicle (UAV) UE transmits an event AxHy-based measurement result message to a gNB in a next-generation mobile communication system according to an embodiment of the disclosure.

The UAV UE may be a UE that is able to fly. Accordingly, the UAV UE has a characteristic of having a higher probability of line of sight than a terrestrial UE. Therefore, the UAV UE may have a disadvantage of receiving downlink (hereinafter, referred to as DL) interference from more cells compared to the terrestrial UE. That is, the UAV UE has a characteristic of receiving DL interference at a high level from more neighboring cells compared to the terrestrial UE. Similarly, the UAV UE has a characteristic of giving uplink (hereinafter, referred to as UL) interference to more cells compared to the terrestrial UE. Accordingly, a method by which the UAV UE reports MeasurementReport to the gNB when a predetermined event is met in a predetermined altitude range area is proposed.

Referring to FIG. 1H, in operation 1h-05, a UAV UE 1h-01 may establish an RRC connection with an NR gNB 1h-02 to be in an RRC-connected mode (RRC_CONNECTED).

In operation 1h-10, the UAV UE 1h-01 may transmit a UE capability information message (UECapabilityInformation) to the gNB 1h-02. This may follow at least one of the above-described embodiments. In addition, the message may include capability information indicating whether the UE 1h-01 supports numberOfTriggeringCells. numberOfTriggeringCells means the number of cells required for satisfying an event that triggers the measurement report, and may be applied only to events considering neighboring cells. For example, the corresponding events may be at least one event among eventA3, eventA4, eventA5, eventA3H1, eventA3H2, eventA4H1, eventA4H2, eventA5H1, and eventA5H2. For reference, description of the above-listed events may be made below.
Event A3: Neighbour becomes amount of offset better than PCell/PSCell.
Event A4: Neighbour becomes better than absolute threshold.
Event A5: PCell/PSCell becomes worse than absolute threshold1 AND Neighbour/SCell becomes better than another absolute threshold2.
Event A3H1: Neighbour becomes offset better than SpCell and the Aerial UE altitude becomes higher than a threshold.
Event A3H2: Neighbour becomes offset better than SpCell and the Aerial UE altitude becomes lower than a threshold.
Event A4H1: Neighbour becomes better than threshold1 and the Aerial UE altitude becomes higher than a threshold2.
Event A4H2: Neighbour becomes better than threshold1 and the Aerial UE altitude becomes lower than a threshold2.
Event A5H1: SpCell becomes worse than threshold1 and neighbour becomes better than threshold2 and the Aerial UE altitude becomes higher than a threshold3.
Event A5H2: SpCell becomes worse than threshold1 and neighbour becomes better than threshold2 and the Aerial UE altitude becomes lower than a threshold3.

In operation 1h-15, the gNB 1h-02 may transmit a predetermined RRC message (for example, RRCReconfiguration) containing measurement configuration information (MeasConfig) to the UE 1h-01. The gNB 1h-02 following the disclosure may configure eventAxHy in the UE 1h-01 through the report configuration information (ReportConfigNR). In addition, the gNB 1h-02 following the disclosure may also configure numberOfTriggeringCells when configuring eventAxHy in the UE 1h-01. For example, the gNB 1h-02 may configure, in the UE 1h-01, a report type (reportType) for each ReportConfigNR as one of eventA3H1, eventA3H2, eventA4H1, eventA4H2, eventA5H1, and eventA5H2, and a format of ASN.1 therefor is as shown in Table 8 below.

TABLE 8

| | |
|---|---|
| ReportConfigNR ::= | SEQUENCE { |
| reportType | CHOICE { |
| periodical | PeriodicalReportConfig, |
| eventTriggered | EventTriggerConfig, |

```
    ...,
    [omitted]
```

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distance ThreshFromReference1-r17 | INTEGER(1..65525), |
| distance ThreshFromReference2-r17 | INTEGER(1..65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]],
    [[
```

| | |
|---|---|
| eventH1-r18 | SEQUENCE { |
| h1-Threshold-r18 | Altitude-r18, |
| h1-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN |

},

| | |
|---|---|
| eventH2-r18 | SEQUENCE { |
| h2-Threshold-r18 | Altitude-r18, |
| h2-Hysteresis-r18 | HysteresisAltitude-r18, |
| reportOnLeave-r18 | BOOLEAN, |
| timeToTrigger-r18 | TimeToTrigger, |
| includeAltitudeUE-r18 | BOOLEAN |

},

| | |
|---|---|
| eventA3H1-r18 | SEQUENCE { |
| a3-Offset-r18 | MeasTriggerQuantityOffset, |
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA3H2-r18 | SEQUENCE { |
| a3-Offset-r18 | MeasTriggerQuantityOffset, |
| reportOnLeave-r18 | BOOLEAN, |
| a3-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

},

| | |
|---|---|
| eventA4H1-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA4H2-r18 | SEQUENCE { |
| a4-Threshold-r18 | MeasTriggerQuantity, |
| reportOnLeave-r18 | BOOLEAN, |
| a4-Hysteresis-r18 | Hysteresis, |
| timeToTrigger-r18 | TimeToTrigger, |
| useAllowedCellList-r18 | BOOLEAN |
| h2-Threshold-r18 | Altitude-r18, |
| h2-Hysteresis-r18 | HysteresisAltitude-r18, |
| includeAltitudeUE-r18 | BOOLEAN |

},

| | |
|---|---|
| eventA5H1-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h1-Threshold-r18 | Altitude-r18, |
| h1-Hysteresis-r18 | HysteresisAltitude-r18, |
| includeAltitudeUE-r18 | BOOLEAN |

},

| | |
|---|---|
| eventA5H2-r18 | SEQUENCE { |
| a5-Threshold1-r18 | MeasTriggerQuantity, |
| a5-Threshold2-r18 | MeasTriggerQuantity, |
| reportOnLeave-r18 | BOOLEAN, |
| a5-Hysteresis-r18 | Hysteresis, |
| timeToTrigger-r18 | TimeToTrigger, |
| useAllowedCellList-r18 | BOOLEAN, |
| h2-Threshold-r18 | Altitude-r18, |
| h2-Hysteresis-r18 | HysteresisAltitude-r18, |
| includeAltitudeUE-r18 | BOOLEAN |

```
    }
    ]]
  },
```

| rsType | NR-RS-Type, | |
|---|---|---|
| reportInterval | ReportInterval, | |
| reportAmount | ENUMERATED {r1, r2, r4, r8, r16, r32, r64, infinity}, | |
| reportQuantityCell | MeasReportQuantity, | |
| maxReportCells | INTEGER (1..maxCellReport), | |
| reportQuantityRS-Indexes | MeasReportQuantity | OPTIONAL, -- Need R |
| maxNrofRS-Indexes ToReport | INTEGER (1..maxNrofIndexesToReport) | OPTIONAL, -- |

Need R

| includeBeamMeasurements | BOOLEAN, | |
|---|---|---|
| reportAddNeighMeas | ENUMERATED {setup} | OPTIONAL, -- Need R |

```
  ...,
  [[
```

| | | |
|---|---|---|
| measRSSI-ReportConfig-r16 | MeasRSSI-ReportConfig-r16 | OPTIONAL, -- Need R |
| use T312-r16 | BOOLEAN | OPTIONAL, -- Need M |
| includeCommonLocationInfo-r16 | ENUMERATED {true} | OPTIONAL, -- Need |

R

| | | |
|---|---|---|
| includeBT-Meas-r16 | SetupRelease {BT-NameList-r16} | OPTIONAL, -- Need M |
| includeWLAN-Meas-r16 | SetupRelease {WLAN-NameList-r16} | OPTIONAL, -- Ne |

ed M

| | | |
|---|---|---|
| includeSensor-Meas-r16 | SetupRelease {Sensor-NameList-r16} | OPTIONAL -- Need |

```
M
  ]],
  [[
```

| | | |
|---|---|---|
| coarseLocationRequest-r17 | ENUMERATED {true} | OPTIONAL, -- Need R |
| reportQuantityRelay-r17 | SL-MeasReportQuantity-r16 | OPTIONAL -- Need R |

```
  ]],
  [[
```

| | | |
|---|---|---|
| numberOfTriggeringCells-r18 | INTEGER (2..maxCellReport) | OPTIONAL -- Need R |

```
  ]]
  }
```

In the case of Event A3H1, the UE 1h-01 may consider that an entering condition for the corresponding event is satisfied when both the condition A3H1-1 and the condition A3H1-2 are satisfied.
Condition A3H1-1: Mn+Ofn+Ocn-Hys1>Mp+Ofp+Ocp+Off
Condition A3H1-2: Ms-Hys2>Thresh

In the case of Event A3H1, the UE 1h-01 may consider that a leaving condition for the corresponding event is satisfied when at least one of the condition A3H1-3 and the condition A3H1-4 is satisfied.
Condition A3H1-3: Mn+Ofn+Ocn+Hys1<Mp+Ofp+Ocp+Off
Condition A3H1-4: Ms+Hys2<Thresh

For reference, the definition for parameters used for the equations of Event A3H1 is described below.

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys1 is the hysteresis parameter for this event (i.e. a3-Hysteresis as defined within reportConfigNR for this event).

Off is the offset parameter for this event (i.e. a3-Offset as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh is the threshold parameter for this event (i.e. h1-Threshold as defined within reportConfigNR for this event).

Mn, Mp are expressed in dBm in case of RSRP, or in dB in case of RSRQ and RS-SINR.

Ofn, Ocn, Hys1, Ofp, Ocp, Off are expressed in dB.

Ms, Hys2, Thresh are expressed in meters.

In the case of Event A3H2, the UE 1h-01 may consider that an entering condition for the corresponding event is satisfied when both the condition A3H2-1 and the condition A3H2-2 are satisfied.
Condition A3H2-1: Mn+Ofn+Ocn-Hys1>Mp+Ofp+Ocp+Off
Condition A3H2-2: Ms+Hys2<Thresh

In the case of Event A3H2, the UE 1h-01 may consider that a leaving condition for the corresponding event is satisfied when at least one of the condition A3H2-3 and the condition A3H2-4 is satisfied.
Condition A3H2-3: Mn+Ofn+Ocn+Hys1<Mp+Ofp+Ocp+Off
Condition A3H2-4: Ms-Hys>Thresh

For reference, the definition for parameters used for the equations of Event A3H2 is described below

Mn is the measurement result of the neighbouring cell, not taking into account any offsets.

Ofn is the measurement object specific offset of the reference signal of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e. offsetMO as defined within measObjectNR corresponding to the SpCell).

Ocp is the cell specific offset of the SpCell (i.e. cellIndividualOffset as defined within measObjectNR corresponding to the SpCell), and is set to zero if not configured for the SpCell.

Hys is the hysteresis parameter for this event (i.e. a3-Hysteresis as defined within reportConfigNR for this event).

Off is the offset parameter for this event (i.e. a3-Offset as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh is the threshold parameter for this event (i.e. h2-Threshold as defined within reportConfigNR for this event).

Mn, Mp are expressed in dBm in case of RSRP, or in dB in case of RSRQ and RS-SINR.

Ofn, Ocn, Hys1, Ofp, Ocp, Off are expressed in dB.

Ms, Hys2, Thresh are expressed in meters.

In the case of Event A4H1, the UE 1h-01 may consider that an entering condition for the corresponding event is satisfied when both the condition A4H1-1 and the condition A4H1-2 are satisfied.
Condition A4H1-1: Mn+Ofn+Ocn-Hys1>Thresh1
Condition A4H1-2: Ms-Hys2>Thresh2

In the case of Event A4H1, the UE 1h-01 may consider that a leaving condition for the corresponding event is satisfied when at least one of the condition A4H1-3 and the condition A4H1-4 is satisfied.
Condition A4H1-3: Mn+Ofn+Ocn+Hys1<Thresh1
Condition A4H1-4: Ms+Hys2<Thresh2

For reference, the definition for parameters used for the equations of Event A4H1 is described below.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a4-Hysteresis as defined within reportConfigNR for this event).

Thresh1 is the threshold parameter for this event (i.e. a4-Threshold as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh2 is the threshold parameter for this event (i.e. h1-Threshold as defined within reportConfigNR for this event).

Mn is expressed in dBm in case of RSRP, or in dB in case of RSRQ and RS-SINR.

Ofn, Ocn, Hys are expressed in dB.

Thresh1 is expressed in the same unit as Mn.

Ms, Hys2, Thresh2 are expressed in meters.

In the case of Event A4H2, the UE 1h-01 may consider that an entering condition for the corresponding event is satisfied when both the condition A4H2-1 and the condition A4H2-2 are satisfied.
Condition A4H2-1: Mn+Ofn+Ocn-Hys1>Thresh1
Condition A4H2-2: Ms+Hys2<Thresh2 In the case of Event A4H2, the UE 1h-01 may consider that a leaving condition for the corresponding event is satisfied when at least one of the condition A4H2-3 and the condition A4H2-4 is satisfied.
Condition A4H2-3: Mn+Ofn+Ocn+Hys1<Thresh1
Condition A4H2-4: Ms-Hys2>Thresh2

For reference, the definition for parameters used for the equations of Event A4H2 is described below.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the measurement object specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a4-Hysteresis as defined within reportConfigNR for this event).

Thresh1 is the threshold parameter for this event (i.e. a4-Threshold as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh2 is the threshold parameter for this event (i.e. h2-Threshold as defined within reportConfigNR for this event).

Mn is expressed in dBm in case of RSRP, or in dB in case of RSRQ and RS-SINR.

Ofn, Ocn, Hys are expressed in dB.

Thresh1 is expressed in the same unit as Mn.

Ms, Hys2, Thresh2 are expressed in meters.

In the case of Event A5H1, the UE 1h-01 may consider that an entering condition for the corresponding event is satisfied when all of the condition A5H1-1, the condition A5H1-2, and A5H1-3 are satisfied.
Condition A5H1-1: Mp+Hys1<Thresh1
Condition A5H1-2: Mn+Ofn+Ocn-Hys1>Thresh2
Condition A5H1-3: Ms-Hys2>Thresh3

In the case of Event A5H1, the UE 1h-01 may consider that a leaving condition for the corresponding event is satisfied when at least one of the condition A5H1-4, the condition A5H1-5, and the condition A5H1-6 is satisfied.
Condition A5H1-4: Mp-Hys1>Thresh1
Condition A5H1-5: Mn+Ofn+Ocn+Hys1<Thresh2
Condition A5H1-6: Ms+Hys2<Thresh3

For reference, the definition for parameters used for the equations of Event A5H1 is described below.

Mp is the measurement result of the NR SpCell, not taking into account any offsets.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a5-Hysteresis as defined within reportConfigNR for this event).

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Ms is the Aerial UE altitude relative to the sea level.

Hys2 is the hysteresis parameter for this event (i.e. h1-Hysteresis as defined within reportConfigNR for this event).

Thresh3 is the threshold parameter for this event (i.e. h1-Threshold as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mn.

Ms, Hys2, Thresh3 are expressed in meters.

In the case of Event A5H2, the UE 1h-01 may consider that an entering condition for the corresponding event is satisfied when all of the condition A5H2-1, the condition A5H2-2, and A5H2-3 are satisfied.
Condition A5H2-1: Mp+Hys1<Thresh1
Condition A5H2-2: Mn+Ofn+Ocn-Hys1>Thresh2
Condition A5H2-3: Ms+Hys2<Thresh3

In the case of Event A5H2, the UE 1h-01 may consider that a leaving condition for the corresponding event is satisfied when at least one of the condition A5H2-4, the condition A5H2-5, and the condition A5H2-6 is satisfied.
Condition A5H2-4: Mp-Hys1>Thresh1
Condition A5H2-5: Mn+Ofn+Ocn+Hys1<Thresh2
Condition A5H2-6: Ms-Hys2>Thresh3

For reference, the definition for parameters used for the equations of Event A5H2 is described below.

Mp is the measurement result of the NR SpCell, not taking into account any offsets.

Mn is the measurement result of the neighbouring cell, not taking into account any offsets.

Ofn is the measurement object specific offset of the neighbour cell (i.e. offsetMO as defined within measObjectNR corresponding to the neighbour cell).

Ocn is the cell specific offset of the neighbour cell (i.e. cellIndividualOffset as defined within measObjectNR corresponding to the neighbour cell), and set to zero if not configured for the neighbour cell.

Hys1 is the hysteresis parameter for this event (i.e. a5-Hysteresis as defined within reportConfigNR for this event).

Thresh1 is the threshold parameter for this event (i.e. a5-Threshold1 as defined within reportConfigNR for this event).

Thresh2 is the threshold parameter for this event (i.e. a5-Threshold2 as defined within reportConfigNR for this event).

Ms is the Aerial UE altitude relative to the sea level.

Hys2 is the hysteresis parameter for this event (i.e. h2-Hysteresis as defined within reportConfigNR for this event).

Thresh3 is the threshold parameter for this event (i.e. h2-Threshold as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mn.

Ms, Hys2, Thresh3 are expressed in meters.

For convenience of description, the disclosure is described based on that reportType of ReportConfigNR is configured as eventTriggered, and eventId of EventTriggerConfig in eventTriggered is configured as eventA4H1. Of course, the following description may be equally applied to other event conditions (for example, eventA3H1, eventA3H2, eventA4H2, eventA5H1, and eventA5H2). For reference, the disclosure is described based on that reportConfig configuring the eventA4H1 includes numberOfTriggeringCells.

In operation 1h-20, the UE 1h-01 may perform measurement, based on the measurement configuration information received in operation 1h-15. This may follow the above-described embodiment.

In operation 1h-25, the UE 1g-01 may determine whether the entry condition for eventA4H1 is satisfied based on the measurement configuration information received in operation 1g-20. Specifically, the UE may determine which cell is applicable as follows.

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the eventA3 or eventA5 or eventA3H1 or eventA3H2 or eventA5H1 or eventA5H2 is configured in the corresponding reportConfig:
         5> if a serving cell is associated with a measObjectNR and neighbours are associated with another measObjectNR, consider any serving cell associated with the other measObjectNR to be a neighbouring cell as well;
         4> for measurement events other than eventA1, eventA2, eventD1, eventX2, eventH1 or eventH2:
         5> if useAllowedCellList is set to true:
         6> consider any neighbouring cell detected based on parameters in the associated measObjectNR to be applicable when the concerned cell is included in the allowedCellsToAddModList defined within the VarMeasConfig for this measId;
         5> else:
         6> consider any neighbouring cell detected based on parameters in the associated measObjectNR to be applicable when the concerned cell is not included in the excludedCellsToAddModList defined within the VarMeasConfig for this measId;
The UE 1h-01 may determine whether the following entry condition applicable to the eventA4H1 is satisfied during timeToTrigger defined by the eventA4H1 within VarMeasConfig corresponding to a UE parameter/
Entry condition:
The case where there is a cell(s) having the measurement results (for example, cell measurement result value) of layer 3 filtering that satisfy the condition A4H1-1 among one or a plurality of cells applicable to Event A4H1 and a flight altitude of the UE 1h-01 satisfies condition A4H1-2

In the embodiment, it is assumed that the number of cell(s) that satisfy the entry condition for the event during timeToTrigger is smaller than umberOfTriggeringCells, and thus the UE 1g-01 may perform the following procedure without initiating the measurement reporting procedure. Specifically, the UE 1h-01 may perform the following procedure.
If the measurement reporting entry is not included in VarMeasReportList for measId linked to the eventA4H1 (the case where a first cell triggers the event),
The measurement reporting entry for measId may be included in VarMeasReportList.
Cells that satisfy the entry condition may be included in cellsTriggeredList defined in VarMeasReportList by measId. For reference, the UE 1h-01 may include, in cellsTriggeredList, only cells that are not included in cellsTriggeredList.
If the number of cell(s) included in cellsTriggeredList is larger than or equal to numberOfTriggeringCells,
numberOfReportsSent defined by measId may be set to 0 in VarMeasReportList.
The measurement reporting procedure may be performed according to operation 1h-30.

In operation 1h-30, the UE 1h-01 may transmit a measurement result message (MeasurementReport) to the gNB 1h-02 according to the following procedure.

For the measId for which the measurement reporting procedure was triggered, the UE shall set the measResults within the MeasurementReport message as follows:
1> set the measId to the measurement identity that triggered the measurement reporting;
1> for each serving cell configured with serving CellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report; measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if the measRSSI-ReportConfig is configured within the corresponding reportConfig for this measId:
   2> set the rssi-Result to the linear average of sample value(s) provided by lower layers in the reportInterval;
   2> set the channelOccupancy to the rounded percentage of sample values which are beyond the channelOccupancyThreshold within all the sample values in the reportInterval;
1> if the UE is acting as L2 U2N Remote UE:
   2> set the sl-MeasResultServingRelay in accordance with the following:
      3> set the cellIdentity to include the cellAccessRelatedInfo contained in the discovery message received from the serving L2 U2N Relay UE;
      3> set the sl-RelayUE-Identity to include the Source L2 ID of the serving L2 U2N Relay;
      3> set the sl-MeasResult to include the SL-RSRP of the serving L2 U2N Relay UE;

NOTE 1: In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
1> if there is at least one applicable neighbouring cell or candidate L2 U2N Relay UE to report:
   2> if the reportType is set to eventTriggered or periodical:
      3> if the measurement report concerns the candidate L2 U2N Relay UE:
         4> set the sl-MeasResultsCandRelay in measResultNeighCells to include the best candidate L2 U2N Relay UEs up to maxNrofRelayMeas in accordance with the following:
         5> if the reportType is set to eventTriggered:
         6> include the L2 U2N Relay UEs included in the relaysTriggeredList as defined within the VarMeasReportList for this measId;
         5> else:
         6> include the applicable L2 U2N Relay UEs for which the new measurement results became available since the last periodical reporting or since the measurement was initiated or reset;
         5> for each L2 U2N Relay UE that is included in the sl-MeasResultsCandRelay:
         6> set the cellIdentity to include the cellAccessRelatedInfo contained in the discovery message received from the concerned L2 U2N Relay UE;
         6> set the sl-RelayUE-Identity to include the Source L2 ID of the concerned L2 U2N Relay UE;
         6> set the sl-MeasResult to include the SD-RSRP of the concerned L2 U2N Relay UE;
         5> for each included L2 U2N Relay UE, include the layer 3 filtered measured results in accordance with the reportConfig for this measId, ordered as follows:
         6> set the sl-MeasResult to include the quantity (ies) indicated in the reportQuantityRelay within the concerned reportConfigRelay in decreasing order of the sorting quantity, determined as specified in 5.5.5.3, i.e. the best L2 U2N Relay UE is included first;
      3> else:
         4> set the measResultNeighCells to include the best neighbouring cells up to maxReportCells in accordance with the following:
         5> if the reportType is set to eventTriggered and eventId is not set to eventD1 or eventH1 or eventH2:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity (ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         7> if the measObject associated with this measId concerns E-UTRA:
         8> set the measResult to include the quantity (ies) indicated in the reportQuantity within the concerned reportConfigInterRAT in decreasing order of the sorting quantity, determined as specified in 5.5.5.3, i.e. the best cell is included first;
         7> if the measObject associated with this measId concerns UTRA-FDD and if ReportConfigInterRAT includes the reportQuantityUTRA-FDD:
         8> set the measResult to include the quantity (ies) indicated in the reportQuantityUTRA-FDD within the concerned reportConfigInterRAT in decreasing order of the sorting quantity, determined as specified in 5.5.5.3, i.e. the best cell is included first;
   2> else:
      3> if the cell indicated by cellForWhichToReportCGI is an NR cell:
         4> if plmn-IdentityInfoList of the cgi-Info for the concerned cell has been obtained:
         5> include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
         5> include frequencyBandList if available;
         5> for each PLMN-IdentityInfo in plmn-IdentityInfoList:
         6> if the gNB-ID-Length is broadcast:
         7> include gNB-ID-Length;
         4> if nr-CGI-Reporting-NPN is supported by the UE and npn-IdentityInfoList of the cgi-Info for the concerned cell has been obtained:
         5> include the npn-IdentityInfoList including npn-IdentityList, trackingAreaCode, ranac (if available), cellIdentity and cellReservedForOperatorUse for each entry of the npn-IdentityInfoList;
         5> for each NPN-IdentityInfo in NPN-IdentityInfoList:
         6> if the gNB-ID-Length is broadcast:
         7> include gNB-ID-Length;
         5> include cellReservedForOtherUse if available;
         4> else if MIB indicates the SIB1 is not broadcast:
         5> include the noSIB1 including the ssb-SubcarrierOffset and pdcch-ConfigSIB1 obtained from MIB of the concerned cell;
      3> if the cell indicated by cellForWhichToReportCGI is an E-UTRA cell:
         4> if all mandatory fields of the cgi-Info-EPC for the concerned cell have been obtained:
         5> include in the cgi-Info-EPC the fields broadcasted in E-UTRA SystemInformationBlockType1 associated to EPC;
         4> if the UE is E-UTRA/5GC capable and all mandatory fields of the cgi-Info-5GC for the concerned cell have been obtained:
         5> include in the cgi-Info-5GC the fields broadcasted in E-UTRA SystemInformationBlockType1 associated to 5GC;
         4> if the mandatory present fields of the cgi-Info for the cell indicated by the cellForWhichToReportCGI in the associated measObject have been obtained:
         5> include the freqBandIndicator;
         5> if the cell broadcasts the multiBandInfoList, include the multiBandInfoList;
         5> if the cell broadcasts the freqBandIndicatorPriority, include the freqBandIndicatorPriority;
1> if the corresponding measObject concerns NR:
   2> if the reportSFTD-Meas is set to true within the corresponding reportConfigNR for this measId:
      3> set the measResultSFTD-NR in accordance with the following:
         4> set sfn-OffsetResult and frame BoundaryOffsetResult to the measurement results provided by lower layers;
         4> if the reportRSRP is set to true;
         5> set rsrp-Result to the RSRP of the NR PSCell derived based on SSB;
   2> else if the reportSFTD-NeighMeas is included within the corresponding reportConfigNR for this measId:
      3> for each applicable cell which measurement results are available, include an entry in the measResultCellListSFTD-NR and set the contents as follows:
         4> set physCellId to the physical cell identity of the concerned NR neighbour cell.
         4> set sfn-OffsetResult and frameBoundaryOffsetResult to the measurement results provided by lower layers;
         4> if the reportRSRP is set to true:
         5> set rsrp-Result to the RSRP of the concerned cell derived based on SSB;
1> else if the corresponding measObject concerns E-UTRA:
   2> if the reportSFTD-Meas is set to true within the corresponding reportConfigInterRAT for this measId:
      3> set the measResultSFTD-EUTRA in accordance with the following:
         4> set sfn-OffsetResult and frame BoundaryOffsetResult to the measurement results provided by lower layers;
         4> if the reportRSRP is set to true;
         5> set rsrpResult-EUTRA to the RSRP of the EUTRA PSCell;
1> if average uplink PDCP delay values are available:
   2> set the ul-PDCP-Delay ValueResultList to include the corresponding average uplink PDCP delay values;
1> if PDCP excess delay measurements are available:
   2> set the ul-PDCP-ExcessDelayResultList to include the corresponding PDCP excess delay measurements;
1> if the includeCommonLocationInfo is configured in the corresponding reportConfig for this measId and detailed location information that has not been reported is available, set the content of commonLocationInfo of the locationInfo as follows:
   2> include the locationTimestamp;
   2> include the locationCoordinate, if available;
   2> include the velocityEstimate, if available;
   2> include the locationError, if available;
   2> include the locationSource, if available;
   2> if available, include the gnss-TOD-msec,
1> if the coarseLocationRequest is set to true in the corresponding reportConfig for this measId:
   2> include coarseLocationInfo, if available;
1> if the includeWLAN-Meas is configured in the corresponding reportConfig for this measId, set the wlan-LocationInfo of the locationInfo in the measResults as follows:
   2> if available, include the LogMeasResultWLAN, in order of decreasing RSSI for WLAN APs;
1> if the includeBT-Meas is configured in the corresponding reportConfig for this measId, set the BT-LocationInfo of the locationInfo in the measResults as follows:
   2> if available, include the LogMeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
   2> if available, include the sensor-MeasurementInformation;
   2> if available, include the sensor-MotionInformation;
1> if the includeAltitudeUE is configured in the corresponding reportConfig for this measId:
   2> set the altitudeUE to include the altitude of the UE;
1> if there is at least one applicable transmission resource pool for NR sidelink communication/discovery (for measResultsSL):
   2> set the measResultsListSL to include the CBR measurement results in accordance with the following:
      3> if the reportType is set to eventTriggered:
         4> include the transmission resource pools included in the poolsTriggeredList as defined within the VarMeasReportList for this measId;
      3> else:
         4> include the applicable transmission resource pools for which the new measurement results became available since the last periodical reporting or since the measurement was initiated or reset;
      3> if the corresponding measObject concerns NR sidelink communication/discovery, then for each transmission resource pool to be reported:
         4> set the sl-poolReportIdentity to the identity of this transmission resource pool;
         4> set the sl-CBR-ResultsNR to the CBR measurement results on PSSCH and PSCCH of this transmission resource pool provided by lower layers, if available;

NOTE 1: Void.
1> if there is at least one applicable CLI measurement resource to report:
   2> if the reportType is set to cli-EventTriggered or cli-Periodical:
      3> set the measResultCLI to include the most interfering SRS resources or most interfering CLI-RSSI resources up to maxReportCLI in accordance with the following:
         4> if the reportType is set to cli-EventTriggered:
         5> if trigger quantity is set to srs-RSRP i.e. i1-Threshold is set to srs-RSRP:
         6> include the SRS resource included in the cli-TriggeredList as defined within the VarMeasReportList for this measId;
         5> if trigger quantity is set to cli-RSSI i.e. i1-Threshold is set to cli-RSSI:
         6> include the CLI-RSSI resource included in the cli-TriggeredList as defined within the VarMeasReportList for this measId;
         4> else:
         5> if reportQuantityCLI is set to srs-rsrp:
         6> include the applicable SRS resources for which the new measurement results became available since the last periodical reporting or since the measurement was initiated or reset;
         5> else:
         6> include the applicable CLI-RSSI resources for which the new measurement results became available since the last periodical reporting or since the measurement was initiated or reset;
         4> for each SRS resource that is included in the measResultCLI:
         5> include the srs-ResourceId;
         5> set srs-RSRP-Result to include the layer 3 filtered measured results in decreasing order, i.e. the most interfering SRS resource is included first;
         4> for each CLI-RSSI resource that is included in the measResultCLI:
         5> include the rssi-ResourceId;
         5> set cli-RSSI-Result to include the layer 3 filtered measured results in decreasing order, i.e. the most interfering CLI-RSSI resource is included first;
1> if there is at least one applicable UE Rx-Tx time difference measurement to report:
   2> set measResultRxTxTimeDiff to the latest measurement result;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> if the measurement reporting was configured by a sl-ConfigDedicatedNR received within the RRCConnectionReconfiguration:
   2> submit the MeasurementReport message to lower layers for transmission via SRB1, embedded in E-UTRA RRC message ULInformationTransferIRAT as specified TS 36.331 [10], clause 5.6.28;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasurementReport message via SRB1 embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.

In operation 1h-35, the UE 1h-01 may determine whether the entry condition for eventA4H1 is satisfied in the future. Specifically, the UE 1h-01 may determine which cell is applicable as follows. This may follow operation 1h-25. The UE 1h-01 may determine whether the following entry condition applicable to the eventA4H1 is satisfied during timeToTrigger defined by the eventA4H1 within VarMeasConfig corresponding to a UE parameter/
Entry condition:
The case where there is a cell(s) having the measurement results (for example, cell measurement result value) of layer 3 filtering that satisfy the condition A4H1 among one or a plurality of cells applicable to Event A4H1 and a flight altitude of the UE 1h-01 satisfies condition A4H1-2

In operation 1h-35, the number of cell(s) included in cellsTriggeredList is already equal to numberOfTriggeringCells or larger than numberOfTriggeringCells, and the UE 1h-01 has a characteristic of not initiating the measurement reporting procedure any more. Specifically, the UE 1h-01 may perform the following procedure.
If the number of cell(s) included in cellsTriggeredList is larger than or equal to numberOfTriggeringCells,
Cells that satisfy the entry condition may be included in cellsTriggeredList defined in VarMeasReportList by measId. For reference, the UE 1h-01 may include, in cellsTriggeredList, only cells that are not included in cellsTriggeredList.

In operation 1h-40, the UE 1h-01 may determine whether to trigger measurement reporting by determining whether the leaving condition for the eventA4H1 is satisfied. Specifically, the UE 1h-01 may determine which cell is applicable as follows. This may follow operation 1h-25. The UE 1h-01 may determine whether at least one following leaving condition is satisfied in associated VarMeasReport within VarMeasReportList for measId linked to eventA4H1 during timeToTrigger defined in VarMeasConfig corresponding to a UE parameter.
Leaving condition 1
The case where there are cells having the measurement results (for example, cell measurement result value) of layer 3 filtering that satisfy the condition A4H-3 among one or a plurality of cells included in cellsTriggerdList defined within VarMeasReportList for measId in operation 1h-25 or operation 1h-35
Leaving condition 2
The case where the flight altitude of the UE 1h-01 satisfies the condition A4H1-4

In the disclosure, when at least one leaving condition is satisfied during timeToTrigger, the UE 1h-01 may perform at least one of the following proposed methods (that is, perform a combination of the following methods or only one method).
Method 1:
If leaving condition 1 is satisfied during timeToTrigger,
Cell(s) that satisfies leaving condition 1 may be removed among cells in cellsTriggeredList defined in measId within VarMeasReportList.
If the removed cell(s) have not been previously transmitted to the gNB 1h-01 through the measurement report message and only leaving condition 1 is satisfied during timeToTrigger, the UE 1h-01 may not initiate the measurement report message even though reportOnLeave is set to true in report configuration information linked to measId.
If cellsTriggeredL is defined in measId within VarMeasReportList is empty,
The measurement reporting entry for measId within VarMeasReportList may be removed.
When a periodical reporting timer is running for measId, the timer may be stopped.
Alternatively, the measurement reporting entry for measId within VarMeasReportList may be removed regardless of whether the cell is included in cellsTriggeredList. If a periodical reporting timer is running for measId, this may be stopped.
Method 2:
If only leaving condition 2 is satisfied during timeToTrigger,
If reportOnLeave is set to true in the report configuration information linked to measId,
The UE 1h-01 may initiate the measurement reporting procedure and transmit the measurement report message (MeasurementReport) to the gNB 1h-02 in operation 1h-40. Of course, when both leaving condition 1 and leaving condition 2 are satisfied during timeToTrigger, the UE 1h-01 may initiate the measurement reporting procedure and transmit the measurement report message (MeasurementReport) to the gNB 1h-02 in operation 1h-40. For reference, the message may include information indicating which condition(s) between leaving condition 1 and leaving condition 2 is satisfied. Alternatively, when only leaving condition 2 is satisfied, the UE 1h-01 may not include information included in cellsTriggeredList in the measurement report message.
If cellsTriggeredL is defined in measId within VarMeasReportList is empty,
The measurement reporting entry for measId within VarMeasReportList may be removed.
When a periodical reporting timer is running for measId, the timer may be stopped.
Alternatively, the measurement reporting entry for measId within VarMeasReportList may be removed regardless of whether the cell is included in cellsTriggeredList. If a periodical reporting timer is running for measId, the timer may be stopped.

In method 1, when only leaving condition 1 is satisfied for the eventA4H1 during timeToTrigger but the UE 1h-01 did not previously transmit information on the corresponding removed cells to the gNB 1h-02, the UE 1h-01 may not initiate the measurement reporting procedure even though reportOnLeave is set to true in the reporting configuration information linked to measId. Accordingly, the gNB 1h-02 has an advantage of avoiding wrong prediction about which cells satisfy the entry condition or the leaving condition for the eventA4H1.

In method 2, when the UE 1h-01 satisfies only leaving condition 2 for the eventA4H1 during timeToTrigger (or both leaving condition 1 and leaving condition 2 are satisfied during timeToTrigger) and reportOnLeave is set to true in the reporting configuration information linked to measId, the UE 1h-01 may initiate the measurement reporting procedure and transmit the measurement reporting message to the gNB 1h-02. Accordingly, the gNB 1h-02 may acquire information on the altitude at which the UE 1h-01 is flying and thus efficiently control UE mobility management in the future.

If the measurement reporting procedure is initiated in operation 1h-40, the UE 1h-01 may transmit the measurement result message (MeasurementReport) to the gNB 1h-02 according to the measurement result message transmission procedure in operation 1h-45. This may follow operation 1h-30.

FIG. 1I is a block diagram illustrating an internal structure of a UE according to an embodiment of the disclosure.

Referring to FIG. 1I, the UE includes a radio frequency (RF) processing unit 1i-10, a baseband processing unit 1i-20, a storage unit 1i-30, a controller 1i-40, and the like.

The RF processing unit 1i-10 performs a function for transmitting and receiving a signal through a wireless channel, such as band conversion and amplification of a signal. That is, the RF processing unit 1i-10 up-converts a baseband signal provided from the baseband processing unit 1i-20 into an RF band signal, transmits the RF band signal through an antenna, and then down-converts the RF band signal received through the antenna into a baseband signal. For example, the RF processing unit 1i-10 may include a transmission filter, a reception filter, an amplifier, a mixer, an oscillator, a digital-to-analog convertor (DAC), an analog-to-digital convertor (ADC), and the like. In FIG. 1I, although only one antenna is illustrated, the UE may include a plurality of antennas. The RF processing unit 1i-10 may include a plurality of RF chains. Moreover, the RF processing unit 1i-10 may perform beamforming. For the beamforming, the RF processing unit 1i-10 may control a phase and a size of each signal transmitted/received through a plurality of antennas or antenna elements. The RF processing unit may perform MIMO and receive a plurality of layers when performing the MIMO operation.

The baseband processing unit 1i-20 performs a function for conversion between a baseband signal and a bitstream according to a physical layer standard of a system. For example, in data transmission, the baseband processing unit 1i-20 generates complex symbols by encoding and modulating a transmission bitstream. Further, in data reception, the baseband processing unit 1i-20 reconstructs a reception bitstream by demodulating and decoding a baseband signal provided from the RF processing unit 1i-10. For example, in an orthogonal frequency-division multiplexing (OFDM) scheme, when data is transmitted, the baseband processing unit 1i-20 generates complex symbols by encoding and modulating a transmission bitstream, maps the complex symbols to subcarriers, and then configures OFDM symbols through an inverse fast Fourier transform (IFFT) operation and a cyclic prefix (CP) insertion. Further, in data reception, the baseband processing unit 1i-20 divides the baseband signal provided from the RF processing unit 1i-10 in units of OFDM symbols, reconstructs the signals mapped to the subcarriers through a fast Fourier transform (FFT) operation, and then reconstructs a reception bitstream through demodulation and decoding.

The baseband processing unit 1i-20 and the RF processing unit 1i-10 transmit and receive signals as described above. Accordingly, the baseband processing unit 1i-20 and the RF processing unit 1i-10 may be commonly called a transmitter, a receiver, a transceiver, or a communication unit. Further, at least one of the baseband processing unit 1i-20 and the RF processing unit 1i-10 may include a plurality of communication modules for supporting a plurality of different radio access technologies. In addition, at least one of the baseband processing unit 1i-20 and the RF processing unit 1i-10 may include different communication modules for processing signals in different frequency bands. For example, the different radio access technologies may include a wireless local area network (LAN) (for example, IEEE 802.11) and a cellular network (for example, LTE). Further, the different frequency bands may include a super high frequency (SHF) (for example, 2.NRHz, NRhz) band and a millimeter (mm) wave (for example, 60 GHz) band.

The storage unit 1i-30 stores data such as a basic program, an application, and setting information for the operation of the UE. The storage unit 1i-30 provides stored data in response to a request from the controller 1i-40.

The controller 1i-40 controls the overall operation of the UE according to the embodiments of the disclosure. For example, the controller 1i-40 transmits and receives a signal through the baseband processing unit 1i-20 and the RF processing unit 1i-10. The controller 1i-40 records data in the storage unit 1i-30 and reads the data. To this end, the controller 1i-40 may include at least one processor and/or a multi-connection processing unit 1i-42. For example, the controller 1i-40 may include a communications processor (CP) that performs control for communication, and an application processor (AP) that controls higher layers such as an application layer.

FIG. 1J is a block diagram illustrating a configuration of a base station (BS) according to an embodiment of the disclosure.

Referring to FIG. 1J, the BS may include an RF processing unit 1j-10, a baseband processing unit 1j-20, a backhaul communication unit 1j-30, a storage unit 1j-40, a controller 1j-50, and the like.

The RF processing unit 1j-10 performs a function for transmitting and receiving a signal through a radio channel, such as band conversion and amplification of a signal. That is, the RF processing unit 1j-10 up-converts a baseband signal provided from the baseband processing unit 1j-20 into an RF band signal, transmits the RF band signal through an antenna, and then down-converts the RF band signal received through the antenna into a baseband signal. For example, the RF processing unit 1j-10 may include a transmission filter, a reception filter, an amplifier, a mixer, an oscillator, a DAC, and an ADC. In FIG. 1J, although only one antenna is illustrated, the BS may include a plurality of antennas. Further, the RF processing unit 1j-10 may include a plurality of RF chains. The RF processing unit 1j-10 may perform beamforming. For the beamforming, the RF processing unit 1j-10 may control a phase and a size of each of the signals transmitted and received through a plurality of antennas or antenna elements. The RF processing unit may perform a downlink MIMO operation by transmitting one or more layers.

The baseband processing unit 1j-20 performs a function of conversion between a baseband signal and a bitstream according to a physical-layer standard of the first radio access technology. For example, when transmitting data, the baseband processing unit 1j-20 generates complex symbols by encoding and modulating a transmission bitstream. Further, in data reception, the baseband processing unit 1j-20 reconstructs a reception bitstream by demodulating and decoding a baseband signal provided from the RF processing unit 1j-10. For example, in an OFDM scheme, when data is transmitted, the baseband processing unit 1j-20 may generate complex symbols by encoding and modulating the transmission bitstream, map the complex symbols to subcarriers, and then configure OFDM symbols through an IFFT operation and CP insertion. In addition, when data is received, the baseband processing unit 1j-20 divides a baseband signal provided from the RF processing unit 1j-10 in units of OFDM symbols, recovers signals mapped with subcarriers through an FFT operation, and then recovers a reception bitstream through demodulation and decoding. The baseband processing unit 1j-20 and the RF processing unit 1j-10 transmit and receive signals as described above. Accordingly, the baseband processing unit 1j-20 and the RF processing unit 1j-10 may be commonly referred to as a transmitter, a receiver, a transceiver, a communication unit, or a radio communication unit.

The backhaul communication unit 1j-30 provides an interface for communicating with other nodes within the network. That is, the backhaul communication unit 1j-30 converts a bitstream transmitted to another node, for example, another BS (for example, a secondary BS, a main BS, or the like), a core network, or the like from the BS, into a physical signal and converts a physical signal received from the other node into a bitstream.

The storage unit 1j-40 stores data such as basic programs, application programs, and configuration information for the operation of the BS. Particularly, the storage unit 1j-40 may store information on a bearer allocated to the access UE and a measurement result reported by the accessed UE. Further, the storage unit 1j-40 may store information which is a reference for determining whether or not to allow multiple connections to the UE. In addition, the storage unit 1j-40 provides stored data in response to a request from the controller 1j-50.

The controller 1j-50 controls the overall operation of the BS according to the embodiments of the disclosure. For example, the controller 1j-50 transmits and receives a signal through the baseband processing unit 1j-20 and the RF processing unit 1j-10 or through the backhaul communication unit 1j-30. Further, the controller 1j-50 records data in the storage unit 1j-40 and reads the data. To this end, the controller 1j-50 may include at least one processor and/or a multi-connection processing unit 1j-52.

It should be noted that the configuration diagrams, illustrative diagrams of control/data signal transmission methods, illustrative diagrams of operation procedures, and structural diagrams as illustrated in FIGS. 1A to 1J are not intended to limit the scope of protection of the disclosure. That is, all the constituent units, entities, or operations shown in FIGS. 1A to 1J should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a base station or terminal device. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
transmitting, to a base station, a first message comprising information indicating that the terminal supports of configuration information on an altitude based measurement;
receiving, from the base station, a second message comprising the configuration information on the altitude based measurement, the configuration information on the altitude based measurement comprising information on an altitude range;
identifying whether the terminal is within the altitude range indicated by the information on the altitude range;
in case that the terminal is within the altitude range, performing a measurement based on the configuration information on the altitude based measurement; and
transmitting, to the base station, a third message comprising a result on the measurement,
wherein, after entering the altitude range, the terminal considers the terminal to be in the altitude range while an altitude of the terminal is larger than or equal to a minimum altitude minus a hysteresis value and the altitude of the terminal is smaller than or equal to a maximum altitude plus the hysteresis value.

2. The method of claim 1,
wherein, in case that information on the minimum altitude is absent in the information on the altitude range, the minimum altitude is −420m, and
wherein, in case that information on the maximum altitude is absent in the information on the altitude range, the maximum altitude is 10000m.

3. The method of claim 1, wherein, in case that the altitude of the terminal is larger than or equal to the minimum altitude and the altitude of the terminal is smaller than or equal to the maximum altitude, the terminal considers to have entered the altitude range.

4. The method of claim 1, wherein the performing of the measurement comprises:
in case that configuration information on at least one synchronization signal block (SSB) to be measured for the altitude range is absent in the configuration information on the altitude based measurement, performing the measurement on all SS blocks.

5. The method of claim 1, further comprising:
in case that the terminal is outside altitude ranges indicated by the information on the altitude range, performing a measurement based on information on at least one synchronization signal block (SSB) to be measured not for the altitude range.

6. A method performed by a base station in a wireless communication system, the method comprising:
receiving, from a terminal, a first message comprising information indicating that the terminal supports of configuration information on an altitude based measurement;
transmitting, to the terminal, a second message comprising the configuration information on the altitude based measurement, the configuration information on the altitude based measurement comprising information on an altitude range; and
receiving, from the terminal, a third message comprising a result on a measurement,
wherein, in case that the terminal is within the altitude range, the result on the measurement comprises a result on a measurement based on the configuration information on the altitude based measurement, and
wherein, after entering the altitude range, the terminal is considered to be in the altitude range while an altitude of the terminal is larger than or equal to a minimum altitude minus a hysteresis value and the altitude of the terminal is smaller than or equal to a maximum altitude plus the hysteresis value.

7. The method of claim 6,
wherein, in case that information on the minimum altitude is absent in the information on the altitude range, the minimum altitude is −420m, and
wherein, in case that information on the maximum altitude is absent in the information on the altitude range, the maximum altitude is 10000m.

8. The method of claim 6, wherein, in case that the altitude of the terminal is larger than or equal to the minimum altitude and the altitude of the terminal is smaller than or equal to the maximum altitude, the terminal is considered to have entered the altitude range.

9. The method of claim 6, wherein, in case that configuration information on at least one synchronization signal block (SSB) to be measured for the altitude range is absent in the configuration information on the altitude based measurement, the result on the measurement comprises a result on a measurement on all SS blocks.

10. The method of claim 6, wherein, in case that the terminal is outside altitude ranges indicated by the information on the altitude range, the result on the measurement comprises a result on a measurement based on information on at least one synchronization signal block (SSB) to be measured not for the altitude range.

11. A terminal in a wireless communication system, the terminal comprising:
a transceiver; and
a controller configured to:
transmit, to a base station via the transceiver, a first message comprising information indicating that the terminal supports of configuration information on an altitude based measurement,
receive, from the base station via the transceiver, a second message comprising the configuration information on the altitude based measurement, the configuration information on the altitude based measurement comprising information on an altitude range,
identify whether the terminal is within the altitude range indicated by the information on the altitude range,
in case that the terminal is within the altitude range, perform a measurement based on the configuration information on the altitude based measurement, and
transmit, to the base station via the transceiver, a third message comprising a result on the measurement,
wherein, after entering the altitude range, the terminal considers the terminal to be in the altitude range while an altitude of the terminal is larger than or equal to a minimum altitude minus a hysteresis value and the altitude of the terminal is smaller than or equal to a maximum altitude plus the hysteresis value.

12. The terminal of claim 11,
wherein, in case that information on the minimum altitude is absent in the information on the altitude range, the minimum altitude is −420m, and
wherein, in case that information on the maximum altitude is absent in the information on the altitude range, the maximum altitude is 10000m.

13. The terminal of claim 11, wherein, in case that the altitude of the terminal is larger than or equal to the minimum altitude and the altitude of the terminal is smaller than or equal to the maximum altitude, the terminal considers to have entered the altitude range.

14. The terminal of claim 11, wherein the controller is further configured to:
in case that configuration information on at least one synchronization signal block (SSB) to be measured for the altitude range is absent in the configuration information on the altitude based measurement, perform the measurement on all SS blocks.

15. The terminal of claim 11, wherein the controller is further configured to:
in case that the terminal is outside altitude ranges indicated by the information on the altitude range, perform a measurement based on information on at least one synchronization signal block (SSB) to be measured not for the altitude range.

16. A base station in a wireless communication system, the base station comprising:
a transceiver; and
a controller configured to:
receive, from a terminal via the transceiver, a first message comprising information indicating that the terminal supports of configuration information on an altitude based measurement,
transmit, to the terminal via the transceiver, a second message comprising the configuration information on the altitude based measurement, the configuration information on the altitude based measurement comprising information on an altitude range, and
receive, from the terminal via the transceiver, a third message comprising a result on a measurement,
wherein, in case that the terminal is within the altitude range, the result on the measurement comprises a result on a measurement based on the configuration information on the altitude based measurement, and
wherein, after entering the altitude range, the terminal is considered to be in the altitude range while an altitude of the terminal is larger than or equal to a minimum altitude minus a hysteresis value and the altitude of the terminal is smaller than or equal to a maximum altitude plus the hysteresis value.

17. The base station of claim 16,
wherein, in case that information on the minimum altitude is absent in the information on the altitude range, the minimum altitude is −420m, and
wherein, in case that information on the maximum altitude is absent in the information on the altitude range, the maximum altitude is 10000m.

18. The base station of claim 16, wherein, in case that the altitude of the terminal is larger than or equal to the minimum altitude and the altitude of the terminal is smaller than or equal to the maximum altitude, the terminal is considered to have entered the altitude range.

19. The base station of claim 16, wherein, in case that configuration information on at least one synchronization signal block (SSB) to be measured for the altitude range is absent in the configuration information on the altitude based measurement, the result on the measurement comprises a result on a measurement on all SS blocks.

20. The base station of claim 16, wherein, in case that the terminal is outside altitude ranges indicated by the information on the altitude range, the result on the measurement comprises a result on a measurement based on information on at least one synchronization signal block (SSB) to be measured not for the altitude range.
